(19) United States
(12) Patent Application Publication
(10) Pub. No.: US 2022/0264589 A1
(43) Pub. Date: Aug. 18, 2022

(54) METHOD AND DEVICE FOR REPORTING INFORMATION, METHOD AND DEVICE FOR RECEIVING MESSAGE

(71) Applicant: Samsung Electronics Co., Ltd., Suwon-si, Gyeonggi-do (KR)

(72) Inventors: Feifei SUN, Beijing (CN); Qi XIONG, Beijing (CN); Yi WANG, Beijing (CN); Min WU, Beijing (CN)

(21) Appl. No.: 17/628,072

(22) PCT Filed: Jul. 17, 2020
(86) PCT No.: PCT/KR2020/009437

§ 371 Date: Jan. 18, 2022

(30) Foreign Application Priority Data
Jul. 17, 2019 (CN) 201910647352.9
Aug. 2, 2019 (CN) 201910713078.0
Apr. 21, 2020 (CN) 202010317645.3
May 14, 2020 (CN) 202010407603.9

(51) Int. Cl. H04W 72/12; H04W 52/36

(52) U.S. Cl. CPC H04W 72/1226; H04W 72/1257; H04W 52/365

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The embodiments of the present application provide a method and a device for reporting information and a method, a device for receiving a message and a method and device for data transmission. One method for reporting information includes: receiving auxiliary scheduling information configuration and/or report indication carried in system information; generating auxiliary scheduling information according to the auxiliary scheduling information configuration and/or the report indication; and reporting the auxiliary scheduling information through at least one of Msg1, Msg3, and MsgA. The method for data transmission includes: obtaining configuration information of multiple uplink bandwidth blocks (BWPs); selecting one or more uplink BWPs among the multiple uplink BWPs according to the configuration information of the uplink BWPs, and transmitting a random access request.

### CROSS-REFERENCE TO RELATED APPLICATION(S)

This application is a U.S. National Stage application under 35 U.S.C. § 371 of an International application number PCT/KR2020/009437, filed on Jul. 17, 2020, which is based on and claims priority of a Chinese patent application number 201910647352.9, filed on Jul. 17, 2019, in the Chinese Intellectual Property Office, of a Chinese patent application number 201910713078.0, filed on Aug. 2, 2019, in the Chinese Intellectual Property Office, of a Chinese patent application number 202010317645.3, filed on Apr. 21, 2020, in the Chinese Intellectual Property Office, and of a Chinese patent application number 202010407603.9, filed on May 14, 2020, in the Chinese Intellectual Property Office, the disclosure of each of which is incorporated by reference herein in its entirety.

### TECHNICAL FIELD

The application relates to the field of wireless communication technologies, and in particular, to a method and device for reporting information, a method and device for receiving messages, and a method and device for data transmission.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology. Rel-15 NR (New Radio) is systematically and mainly designed for enhanced mobile broadband (eMBB) communications. Rel-16 is subjected to system optimization and designed to support some other applications, such as enhanced Ultra-Reliable Low Latency Communications (eURLLC), vehicle to everything (V2X) and the like. However, the current NR system has not been optimized for Internet of Things (IoT) devices. In Rel-17, the NR-Light is a very popular topic. It is expected that NR-Light will be optimally designed according to the low power consumption, small size, and low cost, and the like of IoT devices, based on the NR system.

### DISCLOSURE OF INVENTION

### Technical Problem

The new NR-light terminal type will have smaller bandwidth and fewer receiving antennas than eMBB terminal with the lowest requirements of NR. In addition, for the characteristics of sparse data packets of the IoT, the signaling interaction between the terminal and the network may be simplified. For example, data transmission is performed without establishing a Radio Resource Control (RRC) connection state, which may simplify the signaling well, so as to save power consumption. How to support NR-Light users with smaller bandwidth and fewer transmitting and receiving antennas and other users simultaneously on the same carrier is also a problem that needs to be solved.

Currently, in NR, the minimum bandwidth used for an initial bandwidth part (BWP) is about 5 MHz and 50 MHz within frequency range 1 (FR1) and FR2, respectively. In the initial BWP, downlink broadcast information (such as a synchronization signal, a downlink broadcast channel, and system information) and a random access response (RAR) is required be transmitted to the UE. If the initial BWP is set as the minimum bandwidth, then load capacity of the initial BWP of the cell would be limited, and it would not be able to support mass connected IoT devices.

### Solution to Problem

In view of the shortcomings of the existing methods, the application proposes a method and a device for reporting information and a method and a device for receiving a message, which are used to solve the problem of how to implement an early report for an auxiliary scheduling messages.

In a first aspect, a method for reporting information is provided, applied to a user equipment (UE), comprising:

receiving auxiliary scheduling information configuration and/or report indication carried in system information;

generating auxiliary scheduling information according to the auxiliary scheduling information configuration and/or the report indication; and

reporting the auxiliary scheduling information through at least one of Msg1, Msg3, and MsgA.

Optionally, the auxiliary scheduling information comprises at least one of the following:

transmission Power Headroom Report (PHR); Data Volume (DV) information report in UE buffer; channel state information (CSI) report.

Optionally, the auxiliary scheduling information configuration comprises at least one of the following:

configuration information of Power Headroom, configuration information of DV in UE buffer, configuration information of a buffer status, and configuration information of CSI.

Optionally, the report indication comprises at least one of the following:

an indication of PHR, an indication of DV information report in UE buffer, an indication of Buffer Status Report (BSR), and an indication of CSI report.

Optionally, the method further comprises: indicating at least one of a Medium Access Control (MAC) Control Element (CE), MAC header, MAC subheader and a Radio Resource Control (RRC) as a report format of the auxiliary scheduling information according to the system information and/or a Random Access Response (RAR).

Optionally, the reporting the auxiliary scheduling information through at least one of Msg1, Msg3, and MsgA comprises:

ordering the auxiliary scheduling information and logic channels according to priority rule, and generating Msg3 or MsgA for reporting; where the priority rule comprises: a priority of a cell radio network temporary identification (C-RNTI) MAC CE or data from an uplink common control channel (UL-CCCH) is higher, at least one of priorities of BSR MAC CE in Msg3, BSR MAC CE in MsgA, PHR MAC CE in Msg3 and PHR MAC CE in MsgA is lower.

Optionally, the manner of determining a priority order of the logic channels comprises at least one of the following:

the priority order of the logic channels is specified in a protocol in advance;

the priority order of the logic channels is configured through the broadcasted system information; and

the priority order of the logic channels is configured through UE-specific RRC.

Optionally, the auxiliary scheduling information comprises UE capability report, and the UE capability comprises at least one of the following:

maximum bandwidth supported by the UE, maximum number of receiving antennas of the UE, maximum number of transmitting antennas of the UE, maximum uplink multiple-input multiple-output (MIMO) layers supported by the UE, maximum downlink MIMO layers supported by the UE, UE storage space, UE's capability of early data transmission (EDT), UE's capability of reporting the CSI in Msg3, UE's capability of reporting the CSI in MsgA, UE's capability of reporting the PHR in Msg3, and UE's capability of reporting the PHR in MsgA.

Optionally, after reporting that the DV information in the UE buffer is not zero, the method further comprises:

receiving an uplink grant for data transmission in the UE buffer, and transmitting uplink data according to the uplink grant;

a manner of indicating the uplink grant includes at least one of the following:

indicating the uplink grant according to new data indicator (NDI) in Downlink Control Information (DCI) scrambled by Temporary Cell Radio Network Temporary Identifier (TC-RNTI) or the Random Access Cell Radio Network Temporary Identifier (RA-RNTI); and

indicating the uplink grant in Msg4 or MsgB.

In a second aspect, a method for receiving a message is provided, applied to a UE, comprising:

detecting a first Primary Synchronization Signal (PSS) included in a first Synchronization Signal Physical Broadcast Channel Block (SSB) according to a predefined rule; and/or

detecting a second PSS included in a second SSB according to a second synchronization signal raster;

after detecting the first PSS, detecting a first Secondary Synchronization Signal (SSS) included in the first SSB, and receiving a first Physical Broadcast Channel (PBCH) included in the first SSB; and

after detecting the second PSS, detecting a second SSS included in the second SSB, and receiving a second PBCH included in the second SSB.

Optionally, the detecting the first PSS and/or the second PSS according to the predefined rule comprises:

detecting the first PSS according to a first synchronization signal raster; and/or

detecting the second PSS according to the second synchronization signal raster.

Optionally, the offset between the first synchronization signal raster and the second synchronization signal raster is an integer multiple of the subcarrier spacing.

Optionally, the method further comprises: detecting or decoding at least one of the first PSS, the first SSS, and the first PBCH according to at least one of a first preamble and a first scrambling code; and/or

detecting or decoding at least one of the second PSS, the second SSS, and the second PBCH according to at least one of a second preamble and a second scrambling code.

Optionally, when the first PSS and the second PSS are the same, the first SSS and the second SSS are the same, and the first PBCH and the second PBCH are different, the method further comprises:

receiving the first PBCH on a first resource; and/or

receiving the second PBCH on a second resource;

wherein the frequency domain position of the second resource is adjacent to that of the first resource and/or the time domain position of the second resource is spaced from that of the first resource by a preset interval.

Optionally, when the first SSB and the second SSB are the same, the method further comprises at least one of the following:

detecting a Physical Downlink Control Channel (PDCCH) indicating a first System Information Block (SIB) and/or a PDCCH indicating a second SIB according to a control resource set and/or a search space indicated in the PBCH, wherein the PDCCH indicating the first SIB is scrambled by a first System Information Radio Network Temporary Identifier (SI-RNTI), and the PDCCH indicating the second SIB is scrambled by a second SI-RNTI different from the first SI-RNTI;

detecting the PDCCH indicating the first SIB, according to the first control resource set and/or the first search space indicated in the PBCH; and

detecting the PDCCH indicating the second SIB, according to the second control resource set and/or the second search space indicated in the PBCH.

Optionally, the method further comprises determining whether a cell supports the second control resource set and/or the second search space according to an indication information in the PBCH.

In a third aspect, a UE is provided, comprising:

a first processing module, configured to receive auxiliary scheduling information configuration and/or report indication carried in system information;

a second processing module, configured to generate auxiliary scheduling information according to the auxiliary scheduling information configuration and/or the report indication; and

a third processing module is configured to report the auxiliary scheduling information through at least one of Msg1, Msg3, and MsgA.

In a fourth aspect, a UE is provided, comprising:

a fourth processing module, configured to detecting a first Primary Synchronization Signal (PSS) included in a first Synchronization Signal Physical Broadcast Channel Block (SSB) according to a predefined rule; and/or detecting a second PSS included in a second SSB according to a second synchronization signal raster; and

a fifth processing module, configured to after detecting the first PSS, detect a first Secondary Synchronization Signal (SSS) included in the first SSB, and receive a first Physical Broadcast Channel (PBCH) included in the first SSB; after detecting the second PSS, detect a second SSS included in the second SSB, and receive a second PBCH included in the second SSB.

According to another aspect of the present disclosure, a method for data transmission is provided, which is applied to a user equipment (UE), and the method includes: obtaining configuration information of multiple uplink bandwidth blocks (BWPs); selecting one or more uplink BWPs among the multiple uplink BWPs, according to the configuration information of the uplink BWPs, and transmitting a random access request; and/or obtaining configuration information of multiple downlink BWPs; selecting one or more downlink BWPs among the multiple downlink BWPs according to the configuration information of the downlink BWPs, monitoring a physical downlink control channel (PDCCH) indicating a preset message and/or receiving a physical downlink shared channel (PDSCH) carrying the preset message.

Optionally, the configuration information of multiple uplink BWPs and/or the configuration information of multiple downlink BWPs are obtained through at least one of the following manners: obtaining through system information; obtaining through UE specific radio resource control (RRC) messages; obtaining through a manner of pre-specified configuration information of the uplink BWPs in a protocol; and obtaining through a manner of pre-specified configuration information of the downlink BWPs in a protocol.

Optionally, the preset message includes at least one of the following: a paging message, system information, and a message in random access.

Optionally, the message in random access includes at least one of the following: a random access response (RAR), a message MsgA, a message MsgB, a message Msg3, and a contention resolution message.

Optionally, the selecting one or more downlink BWPs among the multiple downlink BWPs according to the configuration information of the multiple downlink BWPs, monitoring the PDCCH for the preset message and/or receiving the PDSCH carrying the preset message includes at least one of the following: selecting one BWP according to the configuration information of the downlink BWPs and BWP indication in the PDCCH, and receiving the PDSCH carrying the preset message on the one BWP; and selecting one or more downlink BWPs among the multiple downlink BWPs according to the configuration information of the downlink BWPs, to monitor the PDCCH for the preset message, selecting one BWP according to the BWP indication in the PDCCH to receive the PDSCH carrying the preset message on the one BWP, and continue to monitor the PDCCH for the preset message continues on the one or more multiple downlink BWPs after receiving the PDSCH carrying the preset message on the one BWP.

Optionally, the multiple uplink BWPs include one anchor uplink BWP and at least one non-anchor uplink BWP; and/or, the multiple downlink BWPs comprise one anchor downlink BWP and at least one non-anchor downlink BWP.

Optionally, the selecting one or more downlink BWPs among the multiple downlink BWPs according to the configuration information of the multiple downlink BWPs to monitor the PDCCH for the paging message and/or receive the PDSCH carrying the paging message includes at least one of the following: selecting one or more downlink BWPs among the multiple downlink BWPs according to the configuration information of the downlink BWPs and UE identification (ID) to monitor the PDCCH for the paging message and/or receive the PDSCH carrying the paging message; and selecting one or more downlink BWPs among multiple downlink BWPs according to the paging weight and UE ID corresponding to each downlink BWP contained in the configuration information of the downlink BWPs to monitor the PDCCH for the paging message and/or receive the PDSCH carrying the paging message.

Optionally, the selecting one or more uplink BWPs among the multiple uplink BWPs according to the configuration information of the uplink BWPs and transmitting the random access request includes at least one of the following: randomly selecting one or more uplink BWPs among multiple uplink BWPs according to the configuration information of the uplink BWPs and transmitting the random access request; selecting one or more uplink BWPs among the multiple uplink BWPs according to the configuration information of the uplink BWPs and random probability corresponding to each BWP and transmitting the random access request; and randomly selecting a resource for random access request from all resources for the random access requests in the multiple uplink BWPs and transmitting the random access request.

Optionally, the selecting one or more downlink BWPs among the multiple downlink BWPs according to the configuration information of the multiple downlink BWPs to monitor the PDCCH for the message in random access and/or receive the PDSCH carrying the message in random access includes at least one of the following: selecting the corresponding one or more downlink BWPs according to the configuration information of the downlink BWPs and one or more uplink BWPs transmitting the random access request to monitor the PDCCH for the message in random access and/or receive the PDSCH carrying the message in random access; and after transmitting a physical uplink shared channel (PUSCH) or receiving the PDSCH on the BWP indicated by the PDCCH, selecting the corresponding one or more downlink BWPs according to the configuration information of the downlink BWPs and one or more uplink BWPs transmitting the random access request to monitor the PDCCH for the message in random access and/or receive the PDSCH carrying the message in random access.

Optionally, the configuration information of an initial downlink BWP is obtained, wherein the configuration information of the initial downlink BWP includes one or more control channel resource sets (CORESET) and one or more search spaces for the PDCCH for the preset message, the one or more search spaces corresponds to at least one CORESET among the one or more CORESETs; and the PDCCH for the preset message on the one or more search spaces is monitored according to the configuration information of the initial downlink BWP; wherein the at least one CORESET among the one or more CORESETs is smaller than the bandwidth of the initial downlink BWP, and the bandwidth of the initial downlink BWP is greater than the maximum bandwidth supported by the UE.

Optionally, the monitoring the PDCCH for the preset message on the one or more search spaces includes: adjusting the center frequency position for the UE; receiving downlink data on different CORESETs; and decoding the PDCCH.

Optionally, the selecting one or more downlink BWPs among the multiple downlink BWPs according to the configuration information of the multiple downlink BWPs to monitor the PDCCH for the message in random access and/or receive the PDSCH carrying the message in random access includes at least one of the following: decoding and parsing the PDCCH for the message in random access, and obtaining a field in the PDCCH for the BWP on which the PDSCH carrying the message for random access transmission; determining at least one downlink BWP according to the configuration information of the downlink BWP(s) and BWP information indicated by the field in the PDCCH for the BWP on which the PDSCH carrying the message for random access transmission, receiving and decoding the PDSCH carrying the message in random access on the at least one downlink BWP.

Optionally, an uplink BWP indication for transmitting the PUSCH is obtained; and the PUSCH on the uplink BWP is transmitted according to the uplink BWP indication.

Optionally, the obtaining the uplink BWP indication for transmitting the PUSCH includes at least one of the following: obtaining the uplink BWP indication for transmitting the PUSCH from the random access response (RAR) or MsgB; inferring the uplink BWP indication for transmitting the PUSCH according to the BWP for the PDSCH; and determining the uplink BWP indication for transmitting the PUSCH according to the BWP on which transmitting the random access request.

According to another aspect of the present disclosure, a method for data transmission is provided, which is applied to a base station, and the method includes: transmitting radio resource control (RRC) messages indicating configuration information of multiple uplink BWPs; selecting one or more uplink BWPs among the multiple uplink BWPs according to the configuration information of the multiple uplink BWPs, receiving a random access request, and transmitting the PDCCH for RAR resource location, on the downlink BWP corresponding to the received random access request; and/or, transmitting the RRC messages indicating configuration information of multiple downlink BWPs; determining, according to the configuration information of the multiple downlink BWPs and UE ID corresponding to a paging message, one or more BWPs on which the PDCCH for the paging information and/or the PDSCH carrying the paging message are transmitted to the UE; and transmitting the PDCCH for the paging message and/or the PDSCH carrying the paging message on the one or more BWPs.

According to another aspect of the present disclosure, a UE is provided, including: a first processing module configured to obtain configuration information of multiple uplink bandwidth blocks (BWPs); a second processing module configured to select one or more uplink BWPs among the multiple uplink BWPs according to the configuration information of the uplink BWPs, and transmit a random access request; and/or the first processing module configured to obtain configuration information of multiple downlink BWPs; the second processing module configured to select one or more downlink BWPs among the multiple downlink BWPs according to the configuration information of the downlink BWPs, monitoring a physical downlink control channel (PDCCH) indicating a preset message and/or receiving a physical downlink shared channel (PDSCH) carrying the preset message.

According to the other aspect of the present disclosure, a base station is provided, including: a third processing module configured to transmit radio resource control (RRC) messages indicating configuration information of multiple uplink BWPs; a fourth processing module configured to select one or more uplink BWPs among the multiple uplink BWPs according to the configuration information of the multiple uplink BWPs, receive a random access request, and transmit the PDCCH for RAR resource location on the downlink BWP corresponding to the received random access request; and/or, the third processing module configured to transmit the RRC messages indicating configuration information of multiple downlink BWPs; the fourth processing module configured to configured to determine, according to the configuration information of the multiple downlink BWPs and UE ID corresponding to a paging message, one or more BWPs on which the PDCCH for the paging information and/or the PDSCH carrying the paging message are transmitted to the UE, and transmit the PDCCH for the paging message and/or the PDSCH carrying the paging message on the one or more BWPs.

The method in the disclosure is also applicable to the carrier aggregation (CA) scenario. The uplink BWP(s) and/or downlink BWP(s) may be replaced with uplink carrier(s) and/or downlink carrier(s).

### Advantageous Effects of Invention

The technical solutions provided in the embodiments of the present application have at least the following beneficial effects.

auxiliary scheduling information configuration and/or report indication carried in system information is received; auxiliary scheduling information is generated according to the auxiliary scheduling information configuration and/or the report indication; and the auxiliary scheduling information is reported through at least one of Msg1, Msg3, and MsgA. In this way, an early report for the auxiliary scheduling messages is achieved.

The technical solutions provided in the embodiments of the present disclosure have at least the following beneficial effects: obtaining configuration information of multiple uplink bandwidth blocks (BWPs); selecting one or more uplink BWPs among the multiple uplink BWPs, according to the configuration information of the uplink BWPs, and transmitting a random access request; and/or obtaining configuration information of multiple downlink BWPs; selecting one or more downlink BWPs among the multiple downlink BWPs according to the configuration information of the downlink BWPs, monitoring a physical downlink control channel (PDCCH) indicating a preset message and/or receiving a physical downlink shared channel (PDSCH) carrying the preset message. thereby reducing loads of an initial BWP or a primary cell (Pcell) and increasing the number of cell access users.

Additional aspects and advantages of the present application will be given in the following description, which will become apparent from the following description or be learned through the practice of the present application.

### BRIEF DESCRIPTION OF DRAWINGS

In order to explain the technical solutions in the embodiments of the present disclosure more clearly, the drawings used in the description of the embodiments of the present disclosure will be briefly illustrated below.

FIG. 1 is a schematic diagram of a wireless communication system;

FIG. 2 is a schematic diagram of a conventional 4-step random access process;

FIG. 3 is a schematic diagram of a 2-step random access process;

FIG. 4A is a schematic diagram of channel bandwidth configuration;

FIG. 4B is a schematic diagram of channel bandwidth configuration;

FIG. 5 is a schematic flowchart of a method for reporting information according to an embodiment of the present application;

FIG. 6 is a schematic diagram of a random access process according to an embodiment of the present application;

FIG. 7 is a schematic structural diagram of a UE according to an embodiment of the present application;

FIG. 8 is a schematic flowchart of a method for receiving a message according to an embodiment of the present application;

FIG. 9 is a schematic diagram of a Synchronization Signal Block (SSB) on a carrier according to an embodiment of the present application;

FIG. 10 is a schematic diagram of an SSB and a Physical Broadcast Channel (PBCH) according to an embodiment of the present application;

FIG. 11 is a schematic diagram of a SSB and a PBCH provided by an embodiment of the present application;

FIG. 12 is a schematic diagram of finding a corresponding CORSET and a search space where the PDCCH is located according to an indication of an SSB according to an embodiment of the present application;

FIG. 13 is a schematic diagram of obtaining a configuration for a CORESET based on information bits in a PBCH in a detected SSB according to an embodiment of the present application;

FIG. 14 is a schematic structural diagram of another UE according to an embodiment of the present application;

FIG. 15 is a schematic flowchart of a data transmission method according to an embodiment of the present disclosure;

FIG. 16 is a schematic flowchart of another data transmission method according to an embodiment of the present disclosure;

FIG. 17 is a schematic diagram of BWP and search spaces according to an embodiment of the present disclosure;

FIG. 18 is a schematic diagram of BWP and RACH resources according to an embodiment of the present disclosure;

FIG. 19 is a schematic flowchart of another data transmission method according to an embodiment of the present disclosure;

FIG. 20 is a schematic flowchart of yet another data transmission method according to an embodiment of the present disclosure;

FIG. 21 is a schematic diagram of BWP and search spaces according to an embodiment of the present disclosure;

FIG. 22 is a schematic diagram of BWP and CORESET according to an embodiment of the present disclosure;

FIG. 23 is a schematic diagram of obtaining an uplink BWP or a downlink BWP according to an embodiment of the present disclosure;

FIG. 24 is a schematic flowchart of yet another data transmission method according to an embodiment of the present disclosure;

FIG. 25 is a schematic diagram of BWP and search spaces according to an embodiment of the present disclosure;

FIG. 26 is a schematic diagram of BWP and search spaces according to an embodiment of the present disclosure;

FIG. 27 is a schematic diagram of BWP and search spaces according to an embodiment of the present disclosure;

FIG. 28 is a schematic structural diagram of a UE according to an embodiment of the present disclosure; and

FIG. 29 is a schematic structural diagram of a base station according to an embodiment of the present disclosure.

### MODE FOR THE INVENTION

Embodiments of the present application will be described below in detail. The examples of these embodiments have been illustrated in the drawings throughout which same or similar reference numerals refer to same or similar elements or elements having same or similar functions. The embodiments described with reference to the drawings are illustrative, merely used for explaining the present application and should not be regarded as any limitations thereto.

It should be understood by a person of ordinary skill in the art that singular forms “a”, “an”, “the”, and “said” may be intended to include plural forms as well, unless otherwise stated. It should be further understood that terms “include/including” used in this specification specify the presence of the stated features, integers, steps, operations, elements and/or components, but not exclusive of the presence or addition of one or more other features, integers, steps, operations, elements, components, and/or combinations thereof. It should be understood that when a component is referred to as being “connected to” or “coupled to” another component, it may be directly connected or coupled to other elements or provided with intervening elements therebetween. In addition, “connected to” or “coupled to” as used herein may include wireless connection or coupling. As used herein, term “and/or” includes all or any of one or more associated listed items or combinations thereof.

In order to better understand and explain the solutions of the embodiments of the present application, some technologies involved in the embodiments of the present application are briefly described below.

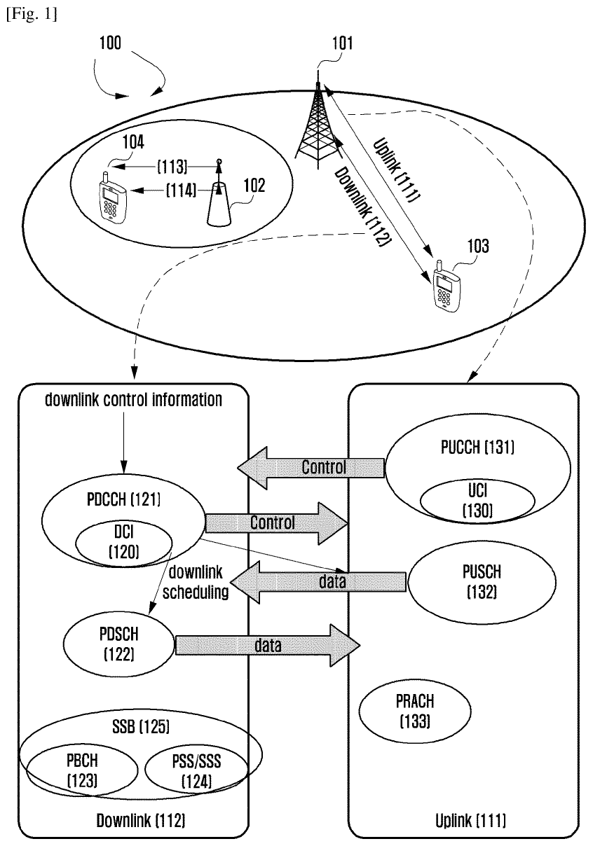

FIG. 1 illustrates an example of a wireless communication system 100, in which includes one or more fixed infrastructure units forming a network distributed over a geographic area. The infrastructure units may include Access Point (AP), Access Terminal (AT), Base Station (BS), Node-B, evolved NodeB (eNB, evolved base station) and Next Generation Base Station (gNB), etc. which may be referred as other terms used in the art.

As shown in FIG. 1, the infrastructure units 101 and 102 provide services for several mobile stations (MSs) or UEs or terminal devices or users 103 and 104 in a service area, and the service area is a cell or within a cell sector. In some systems, one or more BSs are communicatively coupled to a controller forming an access network, and the controller is communicatively coupled to one or more core networks. This example is not limited to any particular wireless communication system.

In the time and/or frequency domains, the infrastructure units 101 and 102 transmit Downlink (DL) communication signals 112 and 113 to the MS or UEs 103 and 104, respectively. MSs or UEs 103 and 104 communicate with infrastructure units 101 and 102 through Uplink (UL) communication signals 111 and 114, respectively.

The wireless communication system 100 is an Orthogonal Frequency Division Multiplexing (OFDM)/Orthogonal Frequency Division Multiple Access (OFDMA) system including multiple base stations and multiple UEs, in which multiple base stations include a base station 101, a base station 102, and multiple UEs include a UE 103 and a UE 104. The base station 101 and the UE 103 communicate through a UL communication signal 111 and a DL communication signal 112.

When the base station has downlink packets to be transmitted to the UE, each UE will obtain a downlink allocation (resource), such as a group of radio resources in the Physical Downlink Shared Channel (PDSCH). When the UE needs to transmit packets to the base station in the uplink, the UE obtains a grant from the base station, where the grant allocates a Physical Uplink Shared Channel (PUSCH) including a set of uplink radio resources. The UE obtains downlink or uplink scheduling information from a Physical Downlink Control Channel (PDCCH) specifically for itself. The downlink or uplink scheduling information and other control information carried by the PDCCH are referred as Downlink Control Information (DCI).

FIG. 1 also shows different physical channels exampled by the downlink 112 and uplink 111. The downlink 112 includes a PDCCH 121, a PDSCH 122, a Physical Broadcast Channel (PBCH) 123, and a Primary Synchronization Signal (PSS)/Secondary Synchronization Signal (SSS) 124. Wherein, in 5G NR, PSS, SSS, and PBCH together constitute an SSB (SS/PBCH block) 125. The PDCCH 121 transmits DCI 120 to the UE, that is, the DCI 120 is carried by the PDCCH 121. The PDSCH 122 transmits downlink data information to the UE. The PBCH carries a Master Information Block (MIB), which is used for UE early discovery and cell-wide coverage. The uplink 111 includes a Physical Uplink Control Channel (PUCCH) 131 carrying Uplink Control Information (UCI) 130, a PUSCH 132 carrying uplink data information, and a Physical Random Access Channel (PRACH) 133 carrying random access information.

In NR, physical resources for the UE monitoring the PDCCH within a time slot is called a Control Resource Set (CORESET). In addition, the base station also configures the aggregation level (AL) and the corresponding search space (such as the period, etc.) for the UE.

The wireless communication network 100 uses OFDMA or a multi-carrier architecture, including Adaptive Modulation and Coding (AMC) on the downlink, and next-generation single-carrier frequency division multiple access (FDMA) architecture or multi-carrier Orthogonal Frequency Division Multiple Access (OFDMA) architecture for UL transmission. FDMA-based single-carrier architecture includes Interleaved FDMA (IFDMA), Localized FDMA (LFDMA), DFT-spread OFDM (DFT-SOFDM) of IFDMA or LFDMA. In addition, various enhanced non-orthogonal multiple access (NOMA) architectures of the OFDMA system are also included.

An OFDMA system serves remote units by allocating downlink or uplink radio resources that typically include a set of subcarriers on one or more OFDM symbols. Example OFDMA protocol includes the developing LTE and 5G NR in the 3GPP UMTS standard, and a series of standards such as IEEE802.16 of the IEEE standard. The architecture may also include the use of transmission technologies, such as multi-carrier CDMA (MC-CDMA), multi-carrier direct sequence CDMA (MC-DS-CDMA), Orthogonal Frequency and Code Division Multiplexing (OFCDM). Alternatively, simpler time and/or frequency division multiplexing/multiple access technologies may be used, or a combination of these different technologies may be used. In an optional implementation manner, the communication system may use other cellular communication system protocols, including but not limited to Time Division Multiple Access (TDMA) or Direct Sequence Code Division Multiple Access (CDMA).

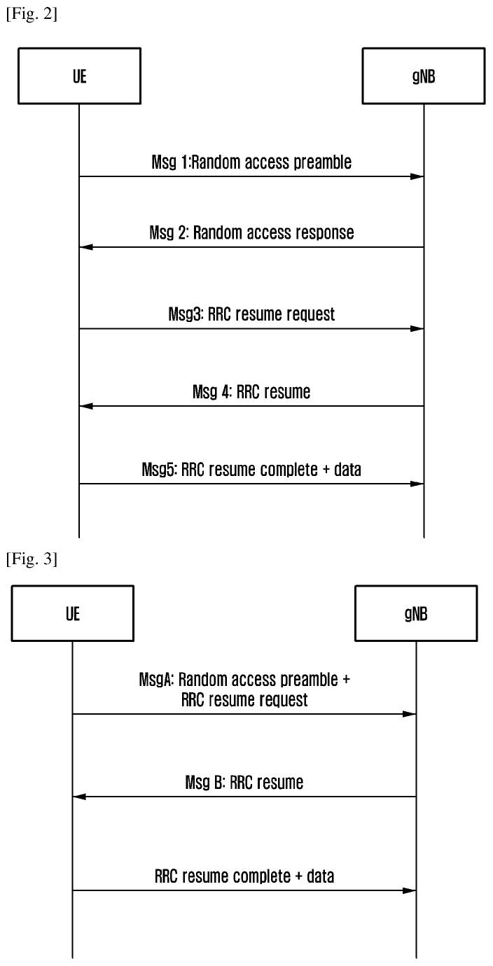

In NR, there are three states: RRC connected state, RRC inactive state, and RRC idle state. Compared with Long Term Evolution (LTE), NR newly introduces the RRC inactive state, which may restore the signaling bearer and establish a data connection through the RRC resume process. As shown in FIG. 2, during the traditional 4-step random access process, the UE transmits an RRC connection resume request in Msg3. The base station may configure the RRC connection for the UE in the Msg4 message at the earliest, and the UE may early transmit the uplink user data together with the RRC resume complete message in Msg5 on the PUSCH. For the 2-step random access process, as shown in FIG. 3, the UE transmits a random access preamble and an RRC resume request in MsgA. The base station may configure the RRC connection for the UE in the MsgB message at the earliest, and the UE may transmit the uplink user data together with the RRC resume complete message in following uplink grant. However, some IoT services are sparse packets, such as transmitted once per second or longer, in 32 bytes, and so on. If these UEs are kept in the connected state, on the one hand, it will increase the storage and operation on the network side, on the other hand, the UE needs to perform some channel state measurements in the connected state to maintain the connected state, thereby increasing the power consumption of the UE. Then, for the transmission of such a packet, the best method is to make the UE in the RRC inactive state or the RRC idle state, and when a packet arrives, the UE makes a random access request and carries user data in Msg3 or MsgA. For stationary users, the pilot part of Msg1 or MsgA may be omitted because of timing advance (TA), thereby achieving a more power-saving effect. This method is called early data transmission (EDT) and has been adopted in narrow band IoT (NB-IoT) and enhanced machine type communication (eMTC) systems. However, in NB-IoT and eMTC, the condition for selecting EDT is that there is no data in the UE buffer. For example, when making an EDT request, the data volume (DV) in the MAC CE of the Data Volume and Power Headroom Report (DPR) in NB-IoT is set to 0, and the data buffer report (BSR) (if reported) in eMTC is also set to 0. Then, this will requires the UE to determine whether the transport block size (TBS) in the PUSCH allocated by the base station is greater than or equal to the data volume in the current buffer when selecting EDT report, otherwise it is necessary to establish an RRC connection before transmitting data. Wherein, the DV in NB-IoT indicates the data volume, which may be used for transmission, stored in the uplink and related to the MAC entity, and the DV may be reported before a Data Radio Bearer (DRB) is established, and/or logic channel or MAC configuration information is received and/or RRC connection is established. The MAC CE of DPR is transmitted as a Common Control Channel (CCCH) service data unit (SDU) in Msg3.

In NR, the base station configures multiple cells for the UE through dedicated messages in the message when (or after) establishing an RRC connection. For example, multiple cells are configured for the UE through an RRC setup message, an RRC reconfiguration message, or an RRC resume message. The base station may configure one or more cell groups for the UE, for example, a master cell group (MCG) and a secondary cell group (SCG). Each of cell groups has a primary cell (Pcell) and one or more secondary cells (Scell). The primary cell in MCG is referred to as Pcell, and the primary cell in SCG is referred to as PScell. In the NR system, common messages such as broadcast message(s), random access related messages, paging message, and the PDCCH(s) indicating these messages are all performed downlink receiving or uplink transmission in the MCG. In addition, random access related messages can be received and transmitted on the PScell in the SCG. After RRC connection setup, a PRACH ordered by the PDCCH may be transmitted on the secondary cell and then the UE receives PDCCH with cell-RNTI (C-RNTI).

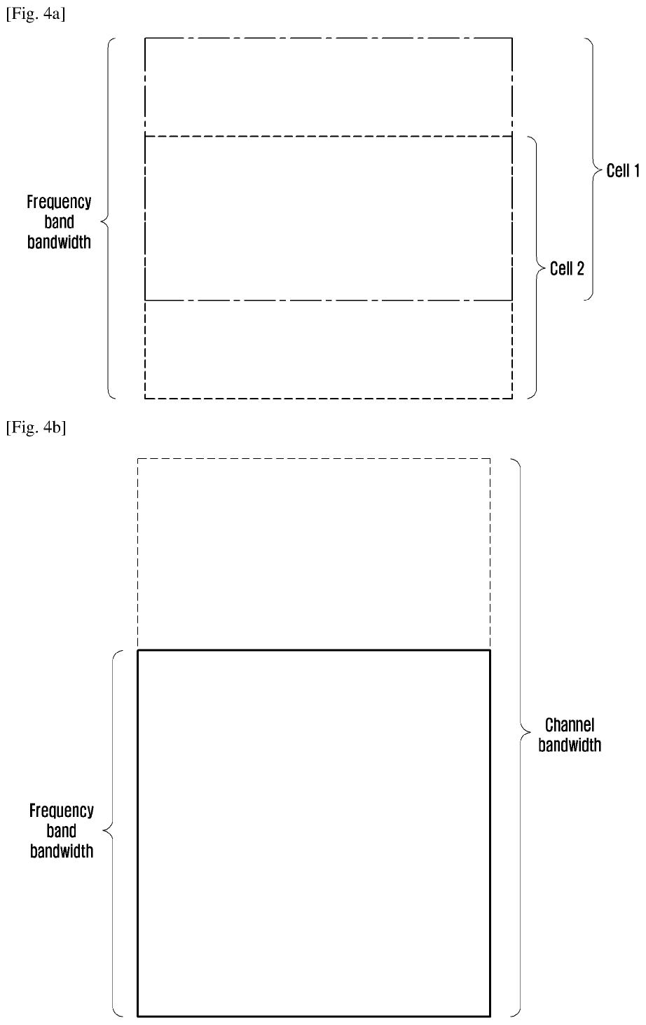

In some bands, the bandwidth owned by the operator is limited and is not an integer multiple of the channel bandwidth values supported by the NR system, for example, 7 MHz. In order to make full use of the bandwidth, multiple cells may be configured for users, and the user throughput may be improved by means of carrier aggregation. As shown in FIG. 4A, the frequency band bandwidth is 7 MHz, and it may be configured with two cells: cell 1 and cell 2 with 5 MHz bandwidth, of which 3 MHz bandwidth is overlapped. Alternatively, a cell with a bandwidth of 5 MHz and a cell with a bandwidth of 2 MHz as the Scell may be configured.

Alternatively, the channel bandwidth of the cell may be configured to be greater than the bandwidth of the frequency band. As shown in FIG. 4B, for a frequency band with a bandwidth of 7 MHz, the channel bandwidth that is used by the base station to broadcast the cell to the user is 10 MHz. Further, the base station ensures that the bandwidth of a BWP is within the band by configuring a small bandwidth of the BWP to the UE. At this time, the base station needs to meet some additional radio frequency (RF) specifications for the band defined by the specification, such as the transmission waveform envelope.

In order to fully utilize the bandwidth of the frequency band and share the load of common messages, for example, paging messages, random access messages and the like may be transmitted on the Scell.

In NR, the UE obtains CORESET 0 in the PBCH and the search space for SIB1, and uses the frequency domain position wherein CORESET 0 is located as the position of the initial BWP. Alternatively, the base station configures the initial BWP for the UE configuration in SIB1. Further, the UE obtains configuration information such as an uplink configuration and a downlink configuration of the initial BWP in SIB1. The downlink configuration information includes one or more of the following information: a search space for the RAR on the BWP, and a search space for other system information on the BWP, one or more control resource set (CORESET), downlink shared channel (PDSCH) configuration, subcarrier spacing of downlink BWP, frequency domain location information of downlink BWP, bandwidth of downlink BWP, and so on. Similarly, the uplink configuration information includes one or more of the following information: random access channel (PRACH) configuration, random access configuration, uplink shared channel (PUSCH) configuration, uplink control channel (PUCCH) configuration, and subcarrier spacing of uplink BWP, frequency domain position information of uplink BWP, bandwidth of uplink BWP, uplink waveform, and so on. The uplink supports two waveforms of DFT-S-OFDM and OFDM. The UE transmits a random access response on the initial uplink BWP according to the random access configuration information in the configuration of the initial BWP in SIB1, and then monitors the search space for RAR on the initial downlink BWP.

In addition, the UE also monitors the paging information according to the search space for paging in SIB1 or UE specific RRC signaling. Specifically, the UE may use discontinuous reception (DRX) in the RRC_IDLE and RRC_INACTIVE states to reduce power consumption. Similarly, DRX technology may also be applied to the RRC_CONNECT state. The UE monitors a paging occasion (PO) for each DRX cycle. The PO is a set of PDCCH monitoring occasions, and may include multiple time slots (e.g., subframes or OFDM symbols) in which a paging DCI can be transmitted. A paging frame (PF) is a radio frame and may contain one or more POs or the starting point of the PO.

In multi-beam operation, the UE assumes that the same paging message is repeated in all transmitted beams, so the selection of the beam used to receive the paging message depends on the UE implementation. The paging message is the same for RAN-initiated paging and CN-initiated paging.

The UE initiates RRC Connection Resume procedure upon receiving RAN initiated paging. If the UE receives a CN (core network) initiated paging in RRC_INACTIVE state, the UE moves to RRC_IDLE and informs NAS (network attached storage).

In NR, the PF and PO for paging are determined by the following formulas.

SFN for PF is determined by:

(SFN+PF_offset)mod T=(T div N)*(UE_ID mod N)

Index (i_s), indicating the index of the PO is determined by:

i_s=floor(UE_ID/N)mod Ns

The PDCCH monitoring occasions for paging are determined according to the pagingSearchSpace as specified in TS 38.213 [4] and the firstPDCCH-MonitoringOccasionOfPO configured (if configured) as specified in TS 38.331 [3]. When SearchSpaceld=0 is configured for pagingSearchSpace, the PDCCH monitoring occasions for paging are the same as that for RMSI as defined in clause 13 of TS38.213 [4].

When SearchSpaceld=0 is configured for pagingSearchSpace, Ns is either 1 or 2. For Ns=1, there is only one PO, which starts from the first PDCCH monitoring occasion for paging in the PF. For Ns=2, the PO is either in the first half frame (i_s=0) or the second half frame (i_s=1) of the PF.

When a SearchSpaceld other than 0 is configured forpagingSearchSpace, the UE monitors the (i_s+1)^{th} PO. A PO is a set of ‘S’ consecutive PDCCH monitoring occasions, wherein ‘S’ is the number of actually transmitted SSBs which determined according to ssb-PositionsInBurst in SIB1. The K^{th} PDCCH monitoring occasion for paging in the PO corresponds to the K^{th} transmitted SSB. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of the (i_s+1)^{th} PO is the (i_s+1)^{th} value of the firstPDDCCH-MonitoringOccasionOfPO parameter; otherwise, it is equal to i_s*S.

Note 1: A PO may start at the associated PF, or after the PF.

Note 2: The PDCCH monitoring occasions of the PO may span multiple radio frames. When SearchSpaceld other than 0 is configured for paging-SearchSpace, the PDCCH monitoring occasions of a PO may span multiple periods of the paging search space.

The following parameters are used for the calculation the PF and i_s above:

T: DRX cycle of UE (T is determined by the shortest of the UE specific DRX value(s), if configured by RRC or upper layer, and a default DRX value broadcast in the system information. In RRC_IDLE state, if UE specific DRX is not configured by RRC or upper layer, the default value is applied);

N: number of total paging frames in T;

Ns: number of paging occasions for a PF;

PF_offset: offset used for PF determination;

UE_ID: 5G-S-TMSI mod 1024.

Parameters Ns, nAndPagingFrameOffset and the length of the default DRX cycle are signaled in SIB1. The values of N and PF_offset are derived from the parameter nAndPagingFrameOffset as defined in TS 38.331 [3]. The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration.

If the UE has no 5G-S-TMSI, for example, when the UE has not been registered onto the network, the UE shall use as default identity UE_ID=0 in the PF and i_s formulas above. 5G-S-TMSI is a 48-bit long bit string as defined in TS 23.501 [10]. 5G-S-TMSI shall be interpreted as a binary number where the left most bit represents the most significant bit.

For IoT services, due to the limited capabilities of the UE, such as limited bandwidth and limited number of receiving antennas, etc., all uplink and downlink signals need to be transmitted or received within the bandwidth capability of the UE. For example, the UE has only 5 MHz or 10 MHz RF bandwidth. For example, the UE has only one or two receiving antennas, or supports only Layer 1 or Layer 2 MIMO. For such a UE with limited capabilities, in order to achieve the same coverage as other UEs, more downlink resources are needed to compensate for the performance loss caused by the reduced number of receiving antennas. It may bring a performance loss of 3-6 dB after reducing from 2 antennas to 1 antenna, that is, one receiving antenna requires about 2-4 times of downlink resources greater than that required by two receiving antennas. In addition, all downlink channels need to be transmitted within a limited bandwidth, so the initial BWP load will be too large. Therefore, multiple BWPs need to be introduced to transmit downlink broadcast channels (such as system information, paging information, etc.) as well as the random access response and so on to share the load of the downlink initial BWP.

To make the objectives, technical solutions, and advantages of the present application clearer, the embodiments of the present application will be described in further detail below with reference to the accompanying drawings.

### Embodiment 1

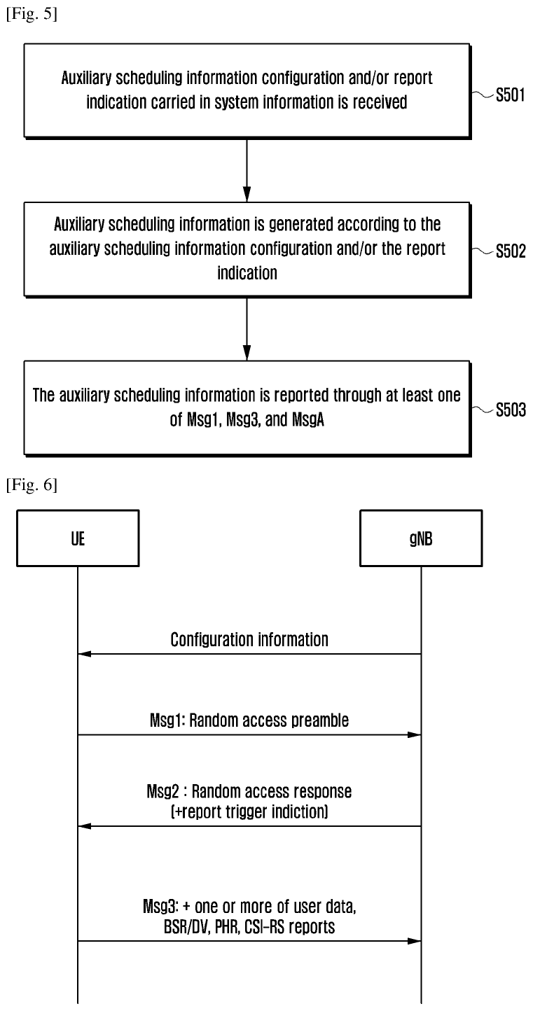

An embodiment of the present application provides a method for reporting information, applied to a UE. A schematic flowchart of the method is shown in FIG. 5. The method includes the following steps.

In Step S501, auxiliary scheduling information configuration and/or report indication carried in system information is received.

In Step S502, auxiliary scheduling information is generated according to the auxiliary scheduling information configuration and/or the report indication.

In Step S503, the auxiliary scheduling information is reported through at least one of Msg1, Msg3, and MsgA.

In the embodiment of the present application, auxiliary scheduling information configuration and/or report indication carried in system information is received; auxiliary scheduling information is generated according to the auxiliary scheduling information configuration and/or the report indication; and the auxiliary scheduling information is reported through at least one of Msg1, Msg3, and MsgA. In this way, the early report of the auxiliary scheduling information is achieved.

Optionally, the auxiliary scheduling information comprises at least one of the following:

transmission Power Headroom Report (PHR); Data Volume (DV) information report in UE buffer; channel state information (CSI) report.

Optionally, the auxiliary scheduling information configuration comprises at least one of the following:

configuration information of Power Headroom, configuration information of DV in UE buffer, configuration information of a buffer status, and configuration information of CSI.

Optionally, the report indication comprises at least one of the following:

an indication of PHR, an indication of DV information report in UE buffer, an indication of Buffer Status Report (BSR), and an indication of CSI report.

Optionally, the method further comprises: indicating at least one of a Medium Access Control (MAC) Control Element (CE), MAC header, MAC subheader and a Radio Resource Control (RRC) as a report format of the auxiliary scheduling information according to the system information and/or a Random Access Response (RAR).

Optionally, the reporting the auxiliary scheduling information through at least one of Msg1, Msg3, and MsgA, comprising:

ordering the auxiliary scheduling information and logic channels according to priority rule, and generating Msg3 or MsgA for reporting; where the priority rule comprises: a priority of a Cell Radio Network Temporary Identifier (C-RNTI) MAC CE or data from an uplink common control channel (UL-CCCH) is higher, at least one of priorities of BSR MAC CE in Msg3, BSR MAC CE in MsgA, PHR MAC CE in Msg3 and PHR MAC CE in MsgA is lower.

Optionally, the manner of determining a priority order of the logic channels comprises at least one of the following:

the priority order of the logic channels is specified in a protocol in advance;

the priority order of the logic channels is configured through the broadcasted system information; and

the priority order of the logic channels is configured through UE-specific RRC.

Optionally, the auxiliary scheduling information comprises UE capability report, and the UE capability comprises at least one of the following:

maximum bandwidth supported by the UE, maximum number of receiving antennas of the UE, maximum number of transmitting antennas of the UE, maximum uplink multiple-input multiple-output (MIMO) layers supported by the UE, maximum downlink MIMO layers supported by the UE, UE storage space, UE's capability of early data transmission (EDT), UE's capability of reporting the CSI in Msg3, UE's capability of reporting the CSI in MsgA, UE's capability of reporting the PHR in Msg3, and UE's capability of reporting the PHR in MsgA.

Optionally, after reporting that the DV information in the UE buffer is not zero, the method further includes:

receiving an uplink grant for data transmission in the UE buffer, and transmitting uplink data according to the uplink grant.

The manner of indicating the uplink grant includes at least one of the following:

indicating the uplink grant according to new data indicator (NDI) in Downlink Control Information (DCI) scrambled by Temporary Cell Radio Network Temporary Identifier (TC-RNTI) or the Random Access Cell Radio Network Temporary Identifier (RA-RNTI); and

indicating the uplink grant in Msg4 or MsgB.

The above embodiments of the present application are comprehensively and thoroughly introduced by the following examples.

In the first aspect, the auxiliary scheduling information report.

For NR terminals, there may be more urgent services (such as URLLC services) and eMBB services that are not very urgent in the buffer, or different IoT service types have different delay requirements. Then, some emergency services may be carried out through EDT, and other services may be transmitted after the RRC connection is established. Alternatively, it is possible to support segmentation of a larger block of data into multiple blocks for EDT transmission separately.

In addition, in order to better allocate appropriate resources for uplink data transmission as soon as possible, the base station needs to know the channel state, uplink transmission power headroom, and the data volume in the current buffer. Then, at least one of the above-mentioned auxiliary scheduling information may be reported in Msg3 or MsgA or Msg1. This method enables the base station to configure appropriate scheduling information (such as appropriate TBS, modulation and coding scheme (MCS), transmission power command (TPC), etc.) as soon as possible to allocate resources for the following data scheduling of Msg1, Msg3, or MsgA, so as to improve transmission efficiency, reduce access delay, and reduce UE power consumption.

Optionally, the auxiliary scheduling information is at least one of the following: transmission Power Headroom Report (PHR); Data Volume (DV) information report in buffer; channel state information (CSI) report.

Optionally, the auxiliary scheduling information configuration and/or the report indication transmitted in system information (SI) specifically includes at least one of the following: configuration information of Power Headroom, an indication of PHR, configuration information of the data volume (buffer status and/or DV) in UE buffer, an indication of BSR and/or DV information report in UE buffer, configuration information of CSI, an indication of CSI report. In one example, the configuration information of auxiliary scheduling information (such as PHR, BSR, DV, CSI, etc.) (auxiliary scheduling information configuration) being received means that the reporting information may be reported or required to be reported.

Optionally, as shown in FIG. 6, the UE receives the auxiliary scheduling information configuration from the base station, the UE transmits a random access request to the base station, and the base station transmits Msg2 (RAR) to the UE. In one example, a trigger indication for reporting auxiliary scheduling information is transmitted in a PDCCH scheduling RAR or a RAR MAC CE or a MAC header or a MAC subheader. Subsequently, the UE transmits the triggered auxiliary scheduling information in Msg3 according to the configuration information and/or the trigger indication in the Msg2 or the PDCCH scheduling Msg2. Similarly, for 2-step random access, the trigger indication for reporting auxiliary scheduling information and the triggered auxiliary scheduling information may be transmitted in the MsgB corresponding to RAR, and the PUSCH in MsgA or the preamble in MsgA corresponding to Msg3, respectively.

Optionally, user data may be transmitted in the Msg3 or the MsgA. At this time, if there are extra bits in the Msg3 or the MsgA to report the DV or the BSR, the data available for transmission in the UE buffer may be reported. The DV or the BSR may be transmitted before the RRC connection is established.

Optionally, the auxiliary scheduling information may be designed with one or more MAC CEs or MAC header or MAC subheader or RRCs, and one of the RRC, the MAC CE or MAC header or MAC subheader is indicated as a report format through system information and/or RAR. The report format includes RRC or MAC information comprising MAC CE or MAC header or MAC subheader. Specifically, like the DPR in the NB-IoT system, the MAC CE may be designed to include two or four bits of power headroom (PH) and four bits of DV, where, the two or four bits of PH is configured according to the system information.

Alternatively, it is possible to design separate MAC CE, similarly to BSR MAC CE and/or PHR MAC CE, and report it in the Msg3 or MsgA before receiving the logic channel configuration and/or BSR configuration and/or PHR configuration and/or completing the RRC connection establishment. In the BSR MAC CE, a logic channel group (LCG) ID is set to a default value, or the first several bits of the BSR reported in the Msg3 or MsgA are set to the reserved value “R”. For the PHR report, it may be defined in advance that only the PHR of the current cell is reported in the Msg3 or MsgA, and PCMAX, c for indicating the maximum transmission power is not reported. Similarly, the first several bits of the PHR reported in the Msg3 or MsgA are set to the reserved value “R”.

Alternatively, the above auxiliary scheduling information may be reported in an RRC message. For example, one or more information elements (IE) may be added to the RRC message transmitted in the Msg3 or MsgA to report one or more auxiliary scheduling information.

In the second aspect, the priority of logic channels.

Optionally, the BSR triggering conditions may include: the system information includes an indication to report BSR (or DV) and/or PHR in Msg3 and/or MsgA; or the report of BSR (or DV) and/or PHR in Msg3 is triggered through RAR.

If the report of BSR (or DV) and/or PHR is triggered, the UE will report the BSR (or DV) and/or PHR in Msg3 or MsgA, and its priority is lower than C-RNTI MAC CE or data from UL-CCCH.

Specifically, logical channels shall be prioritised in accordance with the following order (the highest priority listed first):
C-RNTI MAC CE or data from UL-CCCH;
MAC CE for BSR in Msg3 (or MsgA), and/or MAC CE for PHR in Msg3 (or MsgA);
Configured Grant Confirmation MAC CE;
MAC CE for BSR not in Msg3 (or MsgA), with exception of BSR included for padding;
Single Entry PHR MAC CE or Multiple Entry PHR MAC CE not in Msg3 (or MsgA);
data from any Logical Channel, except data from UL-CCCH;
MAC CE for Recommended bit rate query;
MAC CE for BSR included for padding;

Specifically, if the transport block size (TBS) corresponding to the PUSCH used to transmit Msg3 or MsgA is sufficient, the data in the corresponding buffer is selected and placed in the HARQ entity of Msg3 or MsgA according to the priority order of the above logic channels, until the TBS is fully occupied, and then the data is transmitted on the PUSCH. Optionally, the priority order of the logic channels may be defined in the protocol in advance, or be configured through broadcasted system information or UE-specific RRC. For example, multiple sets of logic channel priorities are defined in advance, and one of them is configured through an RRC message. In addition, the priority order of the logic channels may be determined according to the types of UE (including UE capability, UE type/class, etc.). For example, for a specific UE (such as NR-Light UE), a priority order of logic channels different from that for other UE may be used. Alternatively, when transmitting a specific RRC message, a specific order of logic channels is used. For example, when transmitting one or more of the RRCSetupRequest, RRCResumeRequest, RRCReestablishmenetRequest, and RRCEarlyDataRequest messages, the priority of the BSR follows the C-RNTI MAC CE or data from UL-CCCH, otherwise, follows the Configured Grant Confirmation MAC CE.

Before the RRC connection is established, the user data may be placed in an RRC message (control plane method), or be transmitted on any logic channel other than that transmitting UL-CCCH data besides the RRC (user plane method). If the TBS in the PUSCH for Msg3 or MsgA is not sufficient to carry all user data, the UE may report the DV or BSR in the Msg3. After receiving a non-zero BSR or DV, the base station may transmit extra uplink grant(s) to the UE. The UE uses the extra uplink grant(s) to transmit the remaining uplink data.

In the 4-step random access process, the UE obtains a temporary TC-RNTI in the RAR. After transmitting the Msg3, if the UE reports a non-zero DV or BSR, when an uplink grant is received to indicate a new transmission, the remaining uplink data is transmitted on the uplink grant sequentially. Among them, the new data indicator (NDI) field in the DCI may be used to indicate that the uplink grant is used for Msg3 retransmission or used for other data transmission. The uplink grant may be scrambled by the TC-RNTI and be transmitted on the PDCCH search space and/or CORESET for RAR and/or Msg3 retransmission.

Similarly, in the 2-step random access process, the UE carries data and/or transmits auxiliary information of BSR (or DV) in MsgA. After receiving the MsgA, the base station may transmit the uplink grant scrambled by RA-RNTI to the UE. Similarly, the new data indicator (NDI) field in the DCI may be used to indicate that the uplink grant is used for retransmission of the PUSCH of MsgA or MsgA or used for the remaining data transmission. The uplink grant may be transmitted on the PDCCH search space and/or CORESET for RAR and/or Msg3 retransmission.

Alternatively, the base station may choose to transmit a contention resolution first, that is, an Msg4 or MsgB message, but does not transmit the RRC establishment configuration or RRCearlyDatacomplete message to the UE. After the contention resolution, the base station may transmit a new DCI scrambled by the TC-RNTI to the UE. Alternatively, extra UL grant(s) may be carried in the Msg4 or MsgB message for transmission of the remaining uplink data. This method may effectively avoid system performance loss and UE power loss caused by long-term conflicts between multiple UEs.

After receiving the uplink buffer indicated by the BSR or DV in the PUSCH to be 0, the base station transmits an RRC message identifying the EDT completion to the UE. After the UE receives the EDT completion message, the UE returns to the idle state or inactive state.

In addition, in order to speed up the transmission of uplink data, one or more HARQ processes may be supported, and the HARQ process number is indicated through the PDCCH. The HARQ processes number may be configured by the base station. Then, at this time, only after all the data in the HARQ process is completed, the base station will consider that all uplink transmissions have been completed.

In the above process, the base station may choose to transmit the RRC connection establishment information to the UE at any time.

In addition, in order to prevent the UE from monitoring the PDCCH for a long time and failing to decode it, or the base station does not receive the uplink message transmitted by the UE, a timer may be configured for the UE. The timer may be counted by the maximum number of retransmissions, or an absolute time. When the timer expires, the UE considers that this random access process has failed, or the uplink HARQ process that has not received the ACK has failed.

In the third aspect, UE capability report.

Rel-15/16 requires NR terminals to have 100 MHz/400 MHz bandwidth (frequency range 1/2, FR1/2) and a minimum of four or two receiving antennas. These indispensable requirements make the cost, power consumption, and size of the terminal difficult to meet the use requirements of IoT. Therefore, NR-Light will design a light version of UE type/capability with characteristics, for example, one or more of the following: smaller bandwidth, fewer number of receiving antennas, smaller data storage capacity, and the like. Since the current NR base station learns that the UE supports a minimum bandwidth of 100 MHz, the NR-Light UE supporting a smaller bandwidth may not be able to access the network. For example, before the UE reports its capabilities, it cannot receive system information, cannot monitor the PDCCH, cannot receive RAR and/or MsgB, cannot transmit Msg3, and cannot transmit MsgA (pilot and/or data part). In the current NR system, the UE may report the UE capability in Msg5 (the first PUSCH after the RRC connection is established) at the earliest. In this way, in order to support both NR-Light and other NR UEs, the base station's scheduling for all UEs (eMBB UE and NR-Light UE) is limited to the smallest possible bandwidth of the NR-Light UE. Due to the lack of diversity gain or the reduction of the number of receiving antennas, the overall random access performance will be affected.

Optionally, the auxiliary scheduling information further includes UE capability report. The UE capability includes at least one of the following: the maximum bandwidth supported by the UE, the maximum number of receiving and/or transmitting antennas of the UE, and the maximum uplink and/or downlink MIMO layers supported by the UE, UE storage space, UE's capability of early data transmission (EDT), UE's capability of reporting the CSI in Msg3/MsgA, and UE's capability of reporting the PHR in Msg3/MsgA. In addition, even if some UE's capabilities are reported during the random access process, it may be still needed that the UE reports more detailed capabilities on subsequent uplink channels, based on the demand or based on transmitted or configured information for the base station. In particular, the UE may report to the base station or core network whether it is an NR-light UE. The UE may directly report to the core network through a Non-Access-Stratum (NAS) message (transparently for the base station); or after the UE reports to the base station, the base station reports to the core network. After obtaining the capabilities of the UE, the core network may notify one or more base stations in a tracking area. The UE may be registered. After acquiring the information, the base station may select an appropriate paging information resource for transmitting it to UEs, which may be in the idle state or inactive state, of the cell. In addition, during the communication between the base station and the UE, the UE may be further restricted based on needs. For example, UE does not allow to support voice service configuration or cell handover. This method can avoid wasting of system resources, reduce UE power consumption, and ensure system performance.

For each possible combination of the above capabilities (including one or more capabilities), one bit or more bits may be used to indicate whether to support a specific capability and specifically support one or more of a plurality of capabilities, for example, whether to support 20 MHz bandwidth, and/or whether to support one or two antennas. One or more bits may also be used to indicate whether to support a certain predefined combination, for example, whether to supports 20 MHz bandwidth and two receiving antennas. The predefined combination may be related to the currently operation band. For example, for some specific bands (such as the frequency bands n7, n38, n41, n77, n78, n79 defined in TS38.101), the specific combination may be {1 antenna, 20 MHz bandwidth}, while other combinations are {2 antennas, 20 MHz bandwidth} and/or {1 antenna, 20 MHz bandwidth}. In another example, for different bands, such as FR1 and FR2, one or more UE capabilities are designed in advance, where each UE capability is one or more specific capabilities. For example, for FR1, two UE capabilities (or one of two UE capabilities) are designed: UE capability 1 including 2 receiving antennas and 20 MHz bandwidth, and UE capability 2 including 1 receiving antenna and 20 MHz bandwidth. For FR2, two UE capabilities (or one of two UE capabilities) are designed: UE capability 1 including 40 MHz bandwidth, and UE capability 2 including 100 MHz bandwidth. For different frequencies, UE capabilities are different. Then for different operation bandwidths, the same bits (bits or information elements (IE)) may be used to represent different UE capabilities (including UE capability combinations), which can save signaling overhead. In addition, different UE capabilities will bring different uplink and/or downlink decoding performance. Therefore, after obtaining the UE capabilities, the base station can select an appropriate scheduling to ensure decoding performance. Optionally, different UE capabilities may also be reported in different bits and/or different forms (including using different methods). The more detailed UE capability reporting will require more information bits.

The specific solutions for reporting UE capabilities are as follows. In a specific implementation, one or more combinations of the following methods may be used to achieve the final capability reporting. The base station may also configure one or more of the following methods for reporting UE capabilities. In addition, the same or different UE capability reporting methods may be used for 4-step random access and 2-step random access.

Method 1: different random access resources are configured for the NR-Light UE and the eMBB UE, that is, configuring different resources of Msg1 and/or MsgA.

Optionally, the resources of MsgA include preamble resource of MsgA and/or resource for transmitting PUSCH of MsgA. The resources of Msg1 and/or MsgA include at least one of the following: RACH occasion, time domain of PRACH channel, frequency domain resource of PRACH channel, the number or set of PRACH channel preambles. The resources for transmitting PUSCH in MsgA include one or more of the following: time domain, frequency domain, antenna port, pilot preamble, spreading codeword, etc. PRACH channel includes preambles for transmitting the Msg1 and/or MsgA.

The NR-Light UE and other UEs may share the same PRACH and/or RACH configuration and/or configuration for beam management, and some resources for the NR-Light UE are indicated. The base station may configure the resources for the NR-Light UE as reserved resources and/or resources for non-competitive access; or the base station may configure the resources for the NR-Light UE as a subset of resources for other UEs. At this time, if other UEs using those resources for the NR-Light UE, the subsequent Msg2/3/4 or MsgB will be processed by the base station as those for an NR-Light UE, and the scheduling thereof will be limited. This method may reduce the collision probability of PRACH resources without knowing the proportion of NR-Light UE and other UEs.

Optionally, a set of dedicated resources may also be independently configured for the NR-Light UE. Then the base station may decide whether to configure the set of dedicated resources to share with other UEs or not to share with other UEs. Further, the system information of the NR-Light UE may be different from other UEs.

Method 2: UE capability is reported in Msg3 and/or MsgA.

Optionally, an information element (IE) of the UE capability may be added to the RRC message transmitted by Msg3 or PUSCH of MsgA, such as at least one of the following messages: RRCSetupRequest, RRCResumeRequest, RRCReestablishmenetRequest, RRCEarlyDataRequest message. Taking the RRCSetupRequest message as an example, the maximum bandwidth, and the number of antennas supported by the UE may be added to the RRC message. It may also directly report CSI, BSR, etc.

| RRCSetupRequest message | |
|---|---|
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| establishmentCause | , |

| csi-NL-r17 | CSI-NL- |
|---|---|
| r17, | OPTIONAL, |
| bsr-NL-r17 | BSR-NR- |
| r17, | OPTIONAL, |
| bandwidthSupport-NL-r17 | |
| SupportedBandwidth, | OPTIONAL, |
| antenna-NL-r17 | |
| SupportedAntenna, | OPTIONAL, |

| | |
|---|---|
| spare | BIT STRING (SIZE (x)) |

}

Or a MAC CE supporting UE capability may be designed, or the UE capability is reported through a specific setting in MAC header or MAC subheader (e.g., the special value of LCID or the special value of reserved bits(R)), or the NR-Light UE is bond to a certain MAC CE or MAC header or MAC subheader. For example, the NR-Light UE will report the PDR in Msg3 or MsgA, while other UEs will not report the PDR. In this way, if the base station receives a specific MAC CE or MAC header or MAC subheader in Msg3 or MsgA, it is considered that the bandwidth supported by the UE is limited, and then it will configure an appropriate bandwidth part (BWP) and uplink and downlink physical channel resources for the UE in the subsequent random access configuration information. The UE will also limit subsequent Msg4/MsgB transmissions to the bandwidth that the UE can support. The initial configuration and/or default BWP may be wider than the maximum bandwidth supported by the NR-Light UE, but the base station will limit all uplink and downlink transmissions to the bandwidth supported by NR-Light UE before distinguishing NR-Light UE and other UEs.

Optionally, according to the service requirements of the IoT, a variety of NR-Light UEs with different capabilities may be defined, for example, with supporting maximum 5 MHz, 10 MHz bandwidth, up to 2 or 4 antennas or MIMO layers, etc. The method 1 may only roughly determine whether it is an NR-Light UE, and further report its specific capabilities in Msg3/MsgA and/or subsequent UE capability report message. The method 1 and method 2 may be used at the same time. Or, if more than one types of UE capability is to be reported, the PRACH resources (e.g., time domain, frequency domain, and code domain resources, and the like) may be divided into more than two groups, each of which corresponds to a type of UE capability. Because MsgA includes two parts as preamble and PUSCH. Then, for the 2-step random access process, the UE capabilities may be reported by any combination of time domain, frequency domain, and code domain resources of different preamble (i.e., PRACH), and/or information carried in the PUSCH.

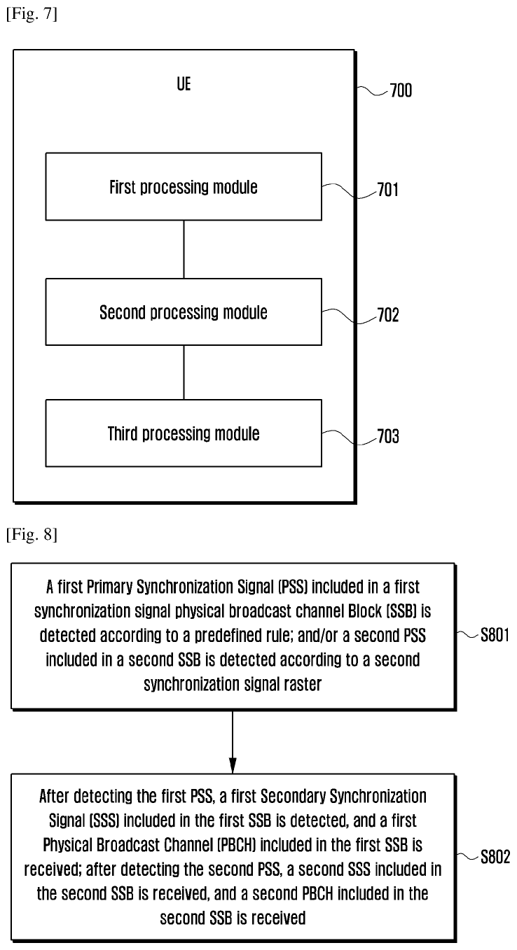

Based on the same inventive concept of the above embodiment 1, an embodiment of the present application further provides a UE. The schematic structure diagram of the UE is shown in FIG. 7. The UE 700 includes a first processing module 701, a second processing module 702, and a third processing module 703.

a first processing module 701, configured to receive auxiliary scheduling information configuration and/or report indication carried in system information;

a second processing module 702, configured to generate auxiliary scheduling information according to the auxiliary scheduling information configuration and/or the report indication; and

a third processing module 703, configured to report the auxiliary scheduling information through at least one of Msg1, Msg3, and MsgA.

Optionally, the auxiliary scheduling information comprises at least one of the following:

transmission Power Headroom Report (PHR); Data Volume (DV) information report in UE buffer; channel state information (CSI) report.

Optionally, the auxiliary scheduling information configuration comprises at least one of the following:

configuration information of Power Headroom, configuration information of DV in UE buffer, configuration information of a buffer status, and configuration information of CSI.

Optionally, report indications comprise at least one of the following:

an indication of PHR, an indication of DV information report in UE buffer, an indication for reporting Buffer Status Report (BSR), and an indication for reporting CSI.

Optionally, the method further comprises: indicating at least one of a Medium Access Control (MAC) Control Element (CE), MAC header, MAC subheader, and a Radio Resource Control (RRC) as a report format of the auxiliary scheduling information according to the system information and/or a Random Access Response (RAR).

Optionally, the third processing module 703 is configured to order the auxiliary scheduling information and logic channel according to priority rule, and generating Msg3 or MsgA for reporting; where the priority rule comprises: a priority of a cell radio network temporary identification (C-RNTI) MAC CE or data from an uplink common control channel (UL-CCCH) is higher, at least one of priorities for BSR MAC CE in Msg3, BSR MAC CE in MsgA, PHR MAC CE in Msg3 and PHR MAC CE in MsgA is lower.

Optionally, the manner of determining a priority order of the logic channels comprises at least one of the following:

the priority order of the logic channels is specified in a protocol in advance;

the priority order of the logic channels is configured through the broadcasted system information;

the priority order of the logic channels is configured through UE-specific RRC.

Optionally, the auxiliary scheduling information comprises UE capability report, and the UE capability comprises at least one of the following:

maximum bandwidth supported by the UE, maximum number of receiving antennas of the UE, maximum number of transmitting antennas of the UE, maximum uplink multiple-input multiple-output (MIMO) layers supported by the UE, maximum downlink MIMO layers supported by the UE, UE storage space, UE's capability of early data transmission (EDT), UE's capability of reporting the CSI in Msg3, UE's capability of reporting the CSI in MsgA, UE's capability of reporting the PHR in Msg3, and UE's capability of reporting the PHR in MsgA.

Optionally, after reporting that the DV information in the UE buffer is not zero, the third processing module 703 is configured to receive an uplink grant for data transmission in the UE buffer, and transmitting uplink data according to the uplink grant; a manner of indicating the uplink grant includes at least one of the following: indicating the uplink grant according to new data indicator (NDI) in Downlink Control Information (DCI) scrambled by Temporary Cell Radio Network Temporary Identifier (TC-RNTI) or the Random Access Cell Radio Network Temporary Identifier (RA-RNTI); indicating the uplink grant in Msg4 or MsgB.

The technical solutions provided in the embodiments of the present application have at least the following beneficial effects:

receiving auxiliary scheduling information configuration and/or report indication carried in system information; generating auxiliary scheduling information according to the auxiliary scheduling information configuration and/or the report indication; and reporting the auxiliary scheduling information through at least one of Msg1, Msg3, and MsgA. This application realizes the early report of the auxiliary scheduling information.

For the content that is not described in detail in the UE provided in this embodiment of the present application, reference may be made to the above-mentioned method for reporting information. The beneficial effects that the UE provided in this embodiment of the present application are the same as the method for reporting the above information, and will not be repeated here.

### Embodiment 2

An embodiment of the present application provides a method for receiving a message, applied to a UE. A schematic flowchart of the method is shown in FIG. 8. The method includes the following steps.

In step S801, a first Primary Synchronization Signal (PSS) included in a first Synchronization Signal Physical Broadcast Channel Block (SSB) is detected according to a predefined rule; and/or a second PSS included in a second SSB is detected according to a second synchronization signal raster.

In step S802, after detecting the first PSS, a first Secondary Synchronization Signal (SSS) included in the first SSB is detected, and a first Physical Broadcast Channel (PBCH) included in the first SSB is received; after detecting the second PSS, a second SSS included in the second SSB is detected, and a second PBCH included in the second SSB is received.

In the embodiments of the present application, it is implemented to support different types of UEs to receive downlink common messages in the same carrier, thereby saving signaling overhead.

Optionally, the UE includes at least one of NR UE and NR-Light UE.

Optionally, detecting the first PSS and/or the second PSS according to the predefined rule comprises:

detecting the first PSS according to a first synchronization signal raster; and/or

detecting the second PSS according to the second synchronization signal raster.

Optionally, an offset between the first synchronization signal raster and the second synchronization signal raster is an integer multiple of a subcarrier spacing.

Optionally, the method further comprises: detecting or decoding at least one of the first PSS, the first SSS, and the first PBCH according to at least one of a first preamble and a first scrambling code; and/or

detecting or decoding at least one of the second PSS, the second SSS, and the second PBCH according to at least one of a second preamble and a second scrambling code.

Optionally, when the first PSS and the second PSS are the same, the first SSS and the second SSS are the same, and the first PBCH and the second PBCH are different, further comprising:

receiving the first PBCH on a first resource; and/or

receiving the second PBCH on a second resource;

wherein the frequency domain position of the second resource is adjacent to that of the first resource and/or the time domain position of the second resource is spaced from that of the first resource by a preset interval.

Optionally, when the first SSB and the second SSB are the same, the method further comprises at least one of the following:

detecting a Physical Downlink Control Channel (PDCCH) indicating a first System Information Block (SIB) and/or a PDCCH indicating a second SIB according to a control resource set and/or a search space indicated in the PBCH, wherein the control resource set includes at least one of a first control resource set and a second control resource set, the search space includes at least one of a first search space and a second search space, and wherein the PDCCH indicating the first SIB is scrambled by a first System Information Radio Network Temporary Identifier (SI-RNTI), and the PDCCH indicating the second SIB is scrambled by a second SI-RNTI different from the first SI-RNTI;

detecting the PDCCH indicating the first SIB, according to the first control resource set and/or the first search space indicated in the PBCH; and

detecting the PDCCH indicating the second SIB, according to the second control resource set and/or a second search space indicated in the PBCH.

Optionally, the method further comprises: determining whether a cell supports the second control resource set and/or the second search space according to an indication information in the PBCH.

The above embodiments of the present application are comprehensively and thoroughly introduced by the following examples.

In the aspect, a method for receiving a downlink common message.

Due to the limited capability of the NR-Light UE, the base station may individually configure a set of downlink common message and/or uplink share channel (such as PRACH) for the NR-Light UE, or limit the bandwidth of the downlink share channel/signal and/or the uplink share channel/signal transmitted to the legacy NR UE within the capability of the NR-Light UE. The former will sacrifice some downlink frequencies, and the latter will sacrifice performance such as coverage of general UEs. Here are some methods for receiving downlink common message.

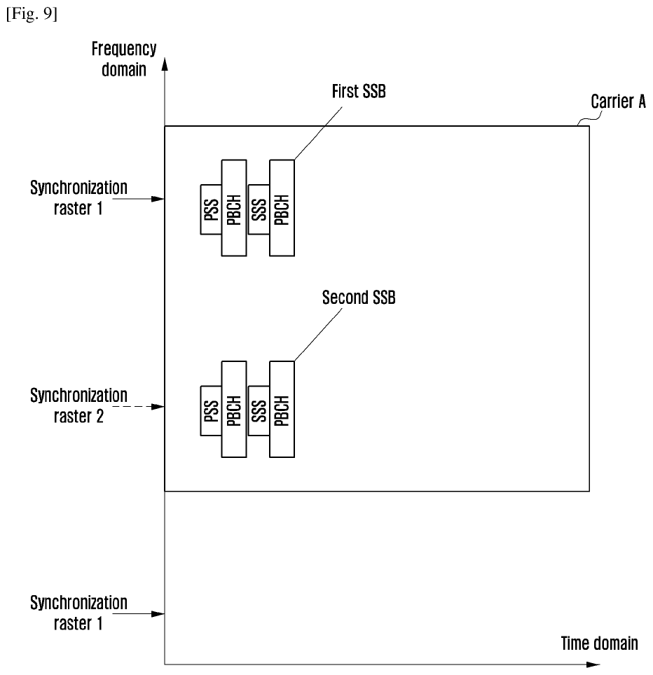

Method 1: Transmitting a set of SSBs for each of the general NR UEs and the NR-Light UEs. As shown in FIG. 9, on one carrier, SSB1 (the first SSB) is an SSB for a general NR UE, and SSB2 (the second SSB) is an SSB for an NR-Light UE. In order not to affect the access of the legacy NR UE, the SSB2 may be placed on a synchronization signal raster different from that used to detect SSB1. For NR, three type of different synchronization signal rasters are defined for different carrier frequency ranges, as shown in Table 1. Then, in order not to affect the access of the legacy UE (the legacy UE will not search for a new SSB for NR-Light UE), the synchronization signal raster corresponding to the NR-Light UE is different from that of the NR UE. For example, as shown in Table 2, a synchronization signal raster for NR-Light adds a variable P1, P2, P3 for each frequency domain range based on the frequency domain position of the synchronization signal raster used for general NR, where, P1, P2, and P3 may be equal to or different from each other. In one example, P1=600 kHz, P2=720 kHz, and P3=8.64 MHz. In this example, the distance between the synchronization signal raster of NR-Light and the synchronization signal raster of NR may be maximized. In addition, a new set of GSCNs may be defined for NR-Light. Table 1 describes NR synchronization signal raster and Table 2 describes NR-Light synchronization signal raster.

TABLE 1

| | Synchronization signal | |
|---|---|---|
| Frequency range | frequency position (SSREF) | GSCN |
| 0~3000 MHz | N × 1200 kHz + M × 50 kHz | [3N + (M − 3)/2] |
| | N = 1:2499, Mε{1, 3, 5} | |
| 3000~24250 MHz | 2400 MHz + N × 1.44 MHz | [7499 + N] |
| | N = 0:14756 | |
| 24250 MHz~100000 | 24250 MHz + N × 17.28 MHz | [22256 + N] |
| MHz | N = 0:4383 | |

Note: GSCN (Global Synchronization Channel Number).

TABLE 2

| | Synchronization signal frequency position |
|---|---|
| Frequency range | (SSREF) |
| 0~3000 MHz | N × 1200 kHz + M × 50 kHz + P1 |
| | N = 1:2499, Mε{1, 3, 5} |
| 3000~24250 MHz | 2400 MHz + N × 1.44 MHz + P2 |
| | N = 0:14756 |
| 24250 MHz~100000 | 24250 MHz + N × 17.28 MHz + P3 |
| MHz | N = 0:4383 |

As shown in FIG. 9, the NR UE uses synchronous raster 1 and the NR-Light UE uses synchronous raster 2. At this time, both the first SSB for the NR UE and the second SSB for the NR-Light UE are transmitted on the carrier A. Wherein, the SSBs for the two types of UEs may be the same cell (i.e., with the same cell identify (ID)), or may be regarded as different cells (different cell IDs). If SSBs for NR UE and NR-Light UE may be transmitted from the same downlink base station on the same carrier, then the OFDM subcarriers or the PRBs serves for two types of UEs is better to be aligned. That is, the offset between the center frequency points of the two SSBs is an integer multiple of the subcarrier spacing (as shown in Tables 1 and 2, the predefined frequency offset is an integer multiple of the corresponding subcarrier spacing). If the offset between the center frequency points of the two SSBs is not an integer multiple of the RB, the kssb indicated in the PBCH may indicate the subcarrier offset of the SSB so that the RBs of the systems corresponding to the two SSBs are aligned, thereby improving spectrum utilization. At this time, the same or different PointA (common RBO) may be configured for the two types of UEs.

Optionally, from the UE perspective, the two systems are mutually transparent. That is, the NR UE does not need to know the existence of the NR-Light UE, and the NR-Light UE does not need to know the position of the SSB of the NR system and the existence of the NR UE. At this time, the share channel may be avoided through the base station configuration, which may avoid extra signaling overhead.

Optionally, the base station may notify the existence of an SSB and other share channels serving another type of UE, such as PRACH resource. It may be transmitted via RRC message on broadcast channel or through UE-specific downlink channel. The advantage is that it may further make the UE aware of the existence of extra SSBs or other share channels serving other type of UEs. When the UE performing transmission or reception, it may avoid broadcast channel/signal for other types of UEs according to predefined or configured rules.

In the method 1, different preambles and/or scrambling codes may be designed for the PSS/SSS/PBCH, thereby further reducing the false alarm probability between the two UEs. However, for a UE supporting two systems, two sets of receiver algorithms are needed to be implemented. Based on different of synchronizing signal rasters, different systems may be effectively distinguished. For terminals supporting two systems, a set of receiver algorithms may be used to search for two types of cells, which may reduce complexity.

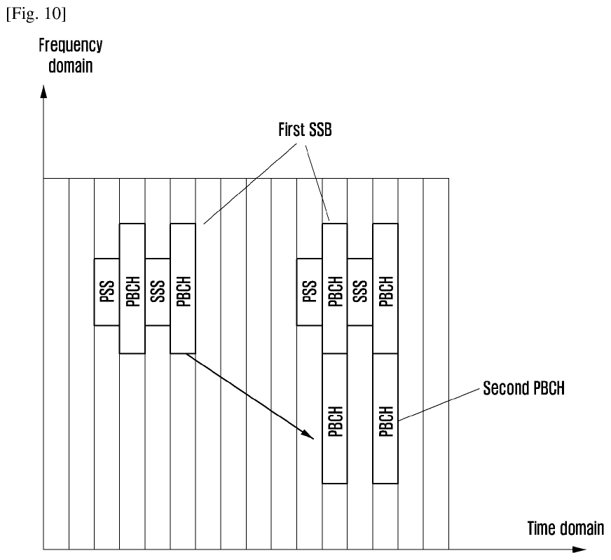

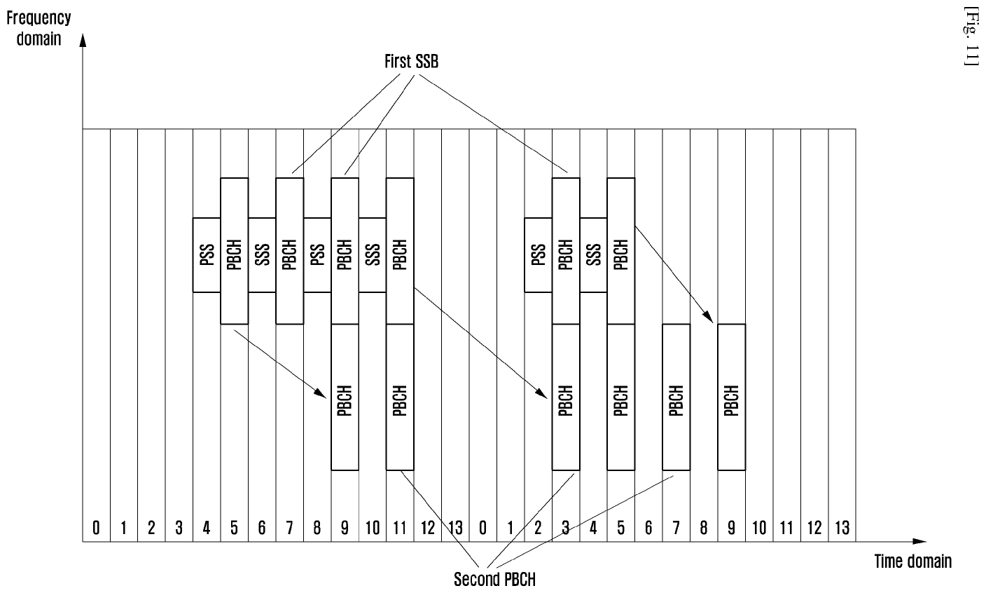

Method 2: Transmitting a set of primary/secondary synchronization signals, but transmitting PBCH (first PBCH) and PBCH-Light (second PBCH) for NR UE and NR-Light UE respectively, where the PBCH-Light is transmitted in a predefined time domain and frequency domain resources, for example, in different time domain positions in the same frequency domain position of the SSB of the NR. As shown in FIG. 10, the first SSB is an SSB of NR, and the second PBCH is a PBCH for NR-Light, and its frequency domain position is predefined as a frequency domain position (high frequency or low frequency) adjacent to the first SSB. In term of time, in order to reduce unnecessary downlink storage of the UE and allow sufficient time for the UE to adjust its RF center frequency point, the second PBCH is in the next PBCH time domain position. For example, for 15 kHz and a carrier frequency less than 3 GHz, if the first SSB is on the symbols 2, 3, 4 and 5, the corresponding second PBCH is on the symbol 9 and symbol 11, and so on.

Optionally, as shown in FIG. 11, for 30 kHz and a carrier frequency less than 3 GHz, or for 120 kHz and a carrier frequency greater than 6 GHz, if the first SSB is on the symbols 4, 5, 6 and 7, the corresponding second PBCH is on the symbol 9 and symbol 11. If the first SSB is on symbols 8-11, the corresponding second PBCH is on symbol 3 and symbol 5 of the next slot, and so on.

Optionally, the second PBCH may be in different time domain position and same frequency domain position as the NR SSB, for example, the previous symbol or next symbol of the NR SSB, or the previous time slot or the next time slot (such as 5 ms or 10 ms) of the NR SSB. This will also affect other NR signals, such as CORESET 0.

Optionally, the PBCH may be transmitted on the different frequency domain resources of SSB of the NR (defined in the protocol in advance, such as a frequency domain position adjacent to the first SSB, but occupying the same symbol). In this way, when the UE detects the PSS/SSS, it cannot store the PBCH in other frequency domain positions, which will cause difficulty in the detection of the UE.

Method 3: The NR-Light UE and the NR UE share a synchronization signal and a physical broadcast channel block (Synchronization Signal/PBCH Block, SSB), but separately transmit a set of SIB1-NL, SIB2-NL, etc. for the NR-Light UE. The NL refers to NR-Light.

There are two specific solutions for method 3.

Solution 1: NR-Light UE and NR UE share Control Resource Set 0 (CORESET 0) and/or search space, but the base station transmits two PDCCHs respectively, indicating different PDSCH bearers: SIB1 and SIB1-NL. The base station instructs DCI of different SIB1 to be scrambled by different SI-RNTI. In addition, DCIs of different sizes may also be designed for NR-Light to distinguish PDCCHs being indicated to NR-Light and other types of UEs.

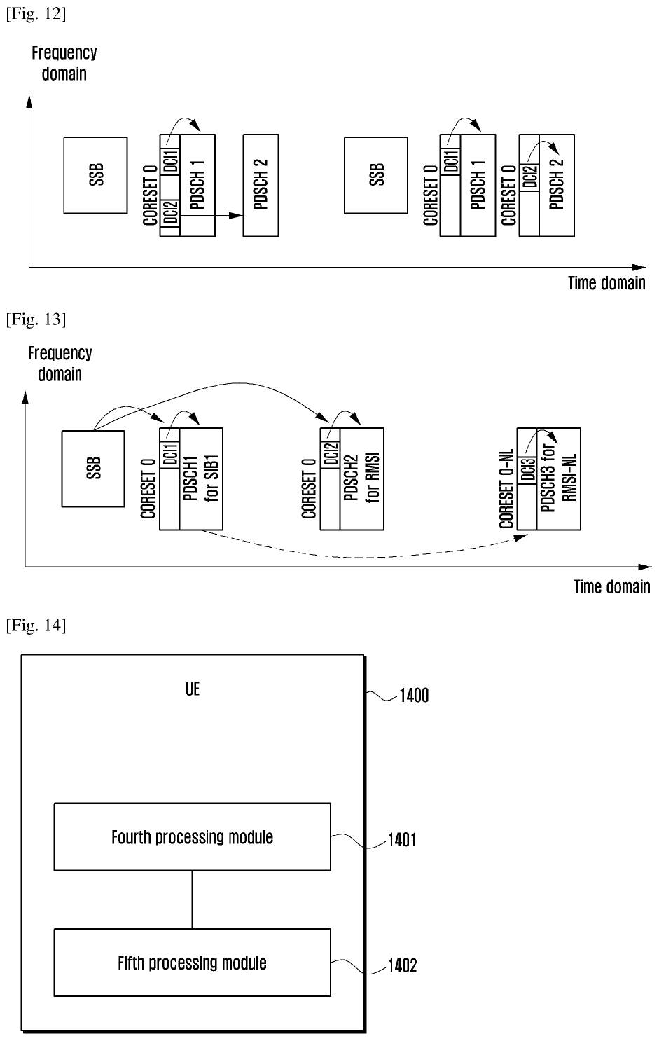

Optionally, as shown in FIG. 12, the UE finds the corresponding CORSET0 and the search space where the PDCCH is located according to the indication of the SSB, and the UE performs PDCCH monitoring. In order to distinguish between different DCIs, the NR UE and the NR-Light UE monitor different SI-RNTIs (configured in the system in advance), respectively. The NR UE successfully decodes a DCI1 scrambled by the SI-RNTI1 to indicate the PDSCH1, where the PDSCH1 carries the SIB1 of the NR UE. The NR-Light UE successfully decodes a DCI2 scrambled by the SI-RNTI2 to indicate the PDSCH2, where the PDSCH2 carries the SIB1-NL of the NR-Light UE, where the DCI1 and the DCI2 may be transmitted in the same search space or search spaces different in time domain.

Optionally, a different length and/or starting position of a monitoring window for SIB1 detection is defined or configured for the NR-Light UE. For example, a longer monitoring window (such as four slots or eight slots) is defined for the NR-Light UE to provide more occasions for transmitting SIB1.

Optionally, the above solution may use an RNTI used by the NR-Light UE for paging, to distinguish from other type of UEs. This method may also be applied to the transmission of common information in sidelink. The method of common channel transmission using different RNTIs may effectively avoid false alarms of the PDCCH, thereby reducing UE power consumption. Compared with the configuration of different control resource sets, different RNTIs may provide more flexible configuration for the base station. The base station specifically transmits the PDCCHs of the PDSCHs indicating the system information for the NR-Light UE and other types of UEs at different time-frequency resources.

Solution 2: In order to reduce the false alarm probability of the UE PDCCH, different CORESET 0 and/or search spaces are defined or configured for the NR-Light UE and the NR UE. Specifically, the second CORESET 0 and/or the second search space may be indicated in the MIB and/or defined according to a predefined rule. Because the reserved bits in the MIB are limited, the table corresponding to the bits in the NR MIB indicating COREST0 and the search space may be extended. That is, the COREST 0 and/or search space of the NR UE correspond to the COREST0-NL and/or search space of the NR-Light one-to-one. NR UE uses the original table, while NR-Light UE uses the extended table.

The NR-Light UE uses CORESET0-NL as the initial BWP, and will monitor paging in CORESET0-NL, and/or search for a PDCCH indicating RAR/MsgB, etc.

For the above two solutions, the base station may configure the CORESET and/or search space where the PDCCH used for transmitting other system information is located in the SIB1-NL.

Optionally, the above solutions 1 and 2 may be used in combination, that is, by defining different RNTIs and configuring the same or different CORESET 0 and/or search spaces (including at least one of the following: period, aggregation level).

Optionally, the NR-Light UE may determine whether the cell supports the NR-Light UE according to the indication information (such as reserved bits) in the PBCH.

Optionally, for the method 1, if the information indicates that the cell supports NR-Light UE, the NR-Light UE obtains the initial BWP, CORESET0, and the search space for scheduling SIB1 of the cell, according to the information bit indicating the control resource set and search space in the system information, and the predefined table for CORESET 0 and search space for NR-light. The NR-Light monitors the second SI-RNTI of the NR-Light UE on the search space.

Optionally, for the method 2, if the information indicates that the cell supports NR-Light UE, the NR-Light UE obtains the initial BWP, CORESET 0-NL and the search space for scheduling SIB1 of the NR-Light UE, according to the information bit indicating the control resource set and the search space in the system information, and the predefined table for CORESET 0-NL and/or search space for NR-light. The search space may also be used for other downlink common information, such as scheduling RAR, Paging, and PDCCH for other system information.

If the indication information in the PBCH does not indicate the support for NR-light UE (for example, no second SI-RNTI and/or no second CORESET0 and/or search space), the NR-Light UE considers that it is prohibited from camping on the cell.

Method 4: The NR-Light UE and the NR UE share other system information (OSI) other than SIB1.

In order to reduce the impact on the NR UE and reduce the load of the initial BWP, the configuration of the RMSI-NL, such as SI-Schedulinglnfo-NL, which may be separately configured in SIB1. It may be the same as or different from the RMSI used for NR. Alternatively, an extra NR-Light may be configured to detect CORESET0-NL and/or search space of RMSI-NL.

As shown in FIG. 13, the NR-Light UE obtains the configuration of CORESET0 according to the information bits in the PBCH in the detected SSB, and monitors CORESET0 to obtain SIB1 for NR-Light. The SIB1 may be a SIB1 shared with the NR UE, for example, adding a new information element (IE) to indicate CORESET 0-NL and/or a corresponding search space. Or, the SIB1 is the SIB1-NL indicated by the NR-Light UE (indicated by any of the methods 1 to 3). At this time, it may effectively reduce the detection of the DCI of SIB1 used for other NR UEs through different RNTIs, thereby avoiding wasteful decoding of the PDSCH channel indicated by the DCI, thereby saving UE power consumption. In SIB1, the NR-Light UE obtains a new CORESET 0-NL and/or a corresponding search space, and monitors the PDCCH according to CORESET 0-NL and the corresponding search space, and obtains DCI3 indicating PDSCH3 carrying RMSI-NL. For the NR UE, the PDCCH is still monitored on CORESET 0 to obtain DCI2 indicating PDSCH2 carrying RMSI-NL.

Optionally, CORESET 0-NL may have different frequency domain resources from CORESET 0. The NR-Light UE uses CORESET 0-NL as the initial BWP, will monitor paging in CORESET 0-NL, and/or search for a PDCCH indicating RAR/MsgB, and so on.

To reduce the power consumption of the UE, whether the cell supports NR-Light UE may be indicated in SIB1. Special barring information may be configured for the NR-Light UE. Or, if the NR-Light UE does not receive any configuration information of the NR-Light UE, it is considered that the cell does not support NR-Light. NR-Light UE cannot camp on this cell.

Method 5: NR-Light UE shares SIB1 and OSI with NR UE. Specific information for NR-Light UE configuration may be added in OSI.

Optionally, for method 4 and method 5, it is also possible to indicate in the PBCH (MIB information) whether the cell supports NR-Light UE to save UE power.

Based on the same inventive concept of the above embodiment 2, an embodiment of the present application further provides a first type UE. The schematic structure diagram of the first type UE is shown in FIG. 14. The first type UE 1400 includes a fourth processing module 1401 and a fifth processing module 1402.

The fourth processing module 1401, configured to detecting a first Primary Synchronization Signal (PSS) included in a first Synchronization Signal physical broadcast channel Block (SSB) according to a predefined rule; and/or detecting a second PSS included in a second SSB according to a second synchronization signal raster;

The fifth processing module 1402 is configured to detect a first secondary synchronization signal SSS included in the first SSB after receiving the first primary synchronization signal PSS, and receive a first physical broadcast channel PBCH included in the first SSB; after detecting the second PSS, the second SSS included in the second SSB is detected, and the second physical broadcast channel (PBCH) included in the second SSB is received.

Optionally, according to a predefined rule, the fourth processing module 1401 is configured to detecting the first PSS according to a first synchronization signal raster; and/or detecting the second PSS according to the second synchronization signal raster.

Optionally, an offset between the first synchronization signal raster and the second synchronization signal raster is an integer multiple of a subcarrier spacing.

Optionally, the fifth processing module 1402 is configured to detecting or decoding at least one of the first PSS, the first SSS, and the first PBCH according to at least one of a first preamble and a first scrambling code; and/or detecting or decoding at least one of the second PSS, the second SSS, and the second PBCH according to at least one of a second preamble and a second scrambling code.

Optionally, when the first PSS and the second PSS are the same, the first SSS and the second SSS are the same, and the first PBCH and the second PBCH is different, the fifth processing module 1402 is configured to receive the first PBCH on a first resource; and/or receive the second PBCH on a second resource; a frequency domain position of the second resource is adjacent to that of the first resource and/or a time domain position of the second resource is spaced from that of the first resource by a preset interval.

Optionally, when the first SSB and the second SSB are the same, the fifth processing module 1402 is configured to detect a Physical Downlink Control Channel (PDCCH) indicating a first System Information Block (SIB) and/or a PDCCH indicating a second SIB according to a control resource set and/or a search space indicated in the PBCH, wherein the control resource set includes at least one of a first control resource set and a second control resource set, the search space includes at least one of a first search space and a second search space, and wherein the PDCCH indicating the first SIB is scrambled by a first System Information Radio Network Temporary Identifier (SI-RNTI), and the PDCCH indicating the second SIB is scrambled by a second SI-RNTI different from the first SI-RNTI; detect the PDCCH indicating the first SIB, according to the first control resource set and/or the first search space indicated in the PBCH; detect the PDCCH indicating the second SIB, according to the second control resource set and/or the second search space indicated in the PBCH.

Optionally, the fifth processing module 1402 is configured to determine whether a cell supports the second control resource set and/or the second search space according to an indication information in the PBCH.

The technical solutions provided in the embodiments of the present application have at least the following beneficial effects.

In the embodiment of the present application, it is implemented to support different types of UEs to receive downlink common messages in the same carrier, thereby saving signaling overhead.

For the content not described in detail in the UE provided in the embodiment of the present application, reference may be made to the foregoing method for receiving a message. The beneficial effects provided by the UE provided in the embodiment of the present application are the same as the foregoing method for receiving a message, and details are not described herein again.

### Embodiment 3

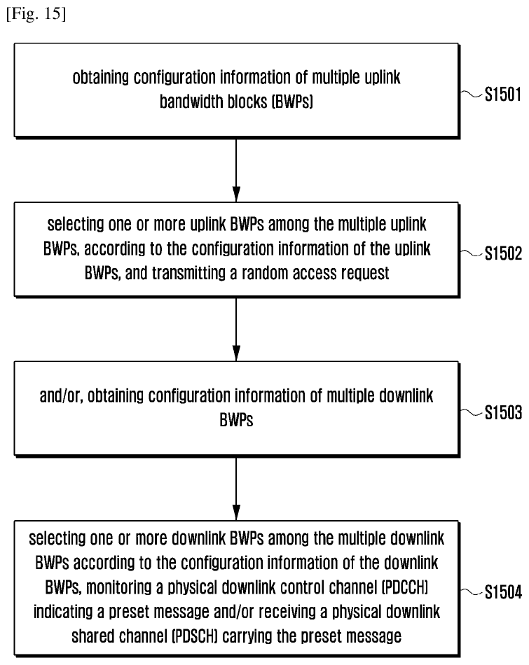

An embodiment of the present disclosure provides a data transmission method, which is applied to a UE. The schematic flowchart of the method is shown in FIG. 15. The method includes the following steps.

Step S1501: configuration information of multiple uplink bandwidth blocks BWP is obtained.

Step S1502: one or more uplink BWPs are selected among the multiple uplink BWPs according to the configuration information of the uplink BWPs, and transmitting a random access request.

Step S1503, and/or, configuration information of multiple downlink BWPs is obtained.

Step S1504: one or more downlink BWPs are selected among the multiple downlink BWPs according to the configuration information of the downlink BWPs, monitoring a physical downlink control channel (PDCCH) indicating a preset message and/or receiving a physical downlink shared channel (PDSCH) carrying the preset message.

In the embodiment of the present disclosure, through obtaining configuration information of multiple uplink bandwidth blocks (BWPs); selecting one or more uplink BWPs among the multiple uplink BWPs according to the configuration information of the uplink BWPs, and transmitting a random access request; and/or obtaining configuration information of multiple downlink BWPs; selecting one or more downlink BWPs among the multiple downlink BWPs according to the configuration information of the downlink BWPs, monitoring a physical downlink control channel (PDCCH) indicating a preset message and/or receiving a physical downlink shared channel (PDSCH) carrying the preset message, thereby reducing loads of an initial BWP and increasing the number of cell access users.

The method in this disclosure is also applicable to the carrier aggregation (CA) scenario. The uplink BWP(s) and/or downlink BWP(s) may be replaced with uplink carrier(s) and/or downlink carrier(s). With this, the load of the Pcell is reduced, and the number of users to access to the system (multiple cells) is increased. For simplicity of description, this disclosure replaces multiple carriers with BWPs.

Optionally, the configuration information of multiple uplink BWPs and/or the configuration information of multiple downlink BWPs are obtained through at least one of the following manners:

obtaining through system information;

obtaining through UE specific radio resource control (RRC) messages;

obtaining through a manner of pre-specified configuration information of the uplink BWPs in a protocol; and

obtaining through a manner of pre-specified configuration information of the downlink BWPs in a protocol.

Optionally, it may be obtained in SIB1 through the system information.

Optionally, the multiple uplink BWPs or multiple downlink BWPs include BWPs for a first type of UEs and BWPs for a second type of UEs. For example, the first type of UEs is legacy NR UEs, and the second type of UEs is NR-light UEs. Optionally, the multiple uplink BWPs or multiple downlink BWPs include one BWP for the first type of UEs and one or more BWPs for the second type of UEs.

Optionally, the configuration information of multiple uplink BWPs and/or the configuration information of multiple downlink BWPs are used for at least one of the following cells: Pcell, Scell, Pscell.

Optionally, the preset message includes at least one of the following:

a paging message, system information, and a message in random access.

Optionally, the message in random access includes at least one of the following:

a random access response (RAR), a message MsgA, a message MsgB, a message Msg3, and a contention resolution message.

Optionally, the selecting one or more downlink BWPs among the multiple downlink BWPs according to the configuration information of the multiple downlink BWPs, monitoring the PDCCH for the preset message and/or receiving the PDSCH carrying the preset message includes at least one of the following:

selecting one BWP according to the configuration information of the downlink BWPs and BWP indication in the PDCCH, and receiving the PDSCH carrying the preset message on the one BWP; and

selecting one or more downlink BWPs among the multiple downlink BWPs according to the configuration information of the downlink BWPs, to monitor the PDCCH for the preset message, selecting one BWP according to the BWP indication in the PDCCH to receive the PDSCH carrying the preset message on the one BWP, and continue to monitor the PDCCH for the preset message continues on the one or more multiple downlink BWPs after receiving the PDSCH carrying the preset message on the one BWP.

Optionally, the multiple uplink BWPs include one anchor uplink BWP and at least one non-anchor uplink BWP; and/or, the multiple downlink BWPs comprise one anchor downlink BWP and at least one non-anchor downlink BWP.

Optionally, the selecting one or more downlink BWPs among the multiple downlink BWPs according to the configuration information of the multiple downlink BWPs to monitor the PDCCH for the paging message and/or receive the PDSCH carrying the paging message includes at least one of the following: selecting one or more downlink BWPs among the multiple downlink BWPs according to the configuration information of the downlink BWPs and UE identification (ID) to monitor the PDCCH for the paging message and/or receive the PDSCH carrying the paging message; and selecting one or more downlink BWPs among multiple downlink BWPs according to the paging weight and UE ID corresponding to each downlink BWP contained in the configuration information of the downlink BWPs to monitor the PDCCH for the paging message and/or receive the PDSCH carrying the paging message.

Optionally, the selecting one or more uplink BWPs among the multiple uplink BWPs according to the configuration information of the uplink BWPs and transmitting the random access request includes at least one of the following: randomly selecting one or more uplink BWPs among multiple uplink BWPs according to the configuration information of the uplink BWPs and transmitting the random access request; selecting one or more uplink BWPs among the multiple uplink BWPs according to the configuration information of the uplink BWPs and random probability corresponding to each BWP and transmitting the random access request; and randomly selecting a resource for random access request from all resources for the random access requests in the multiple uplink BWPs and transmitting the random access request.

Optionally, the selecting one or more downlink BWPs among the multiple downlink BWPs according to the configuration information of the multiple downlink BWPs to monitor the PDCCH for the message in random access and/or receive the PDSCH carrying the message in random access includes at least one of the following: selecting the corresponding one or more downlink BWPs according to the configuration information of the downlink BWPs and one or more uplink BWPs transmitting the random access request to monitor the PDCCH for the message in random access and/or receive the PDSCH carrying the message in random access; and after transmitting a physical uplink shared channel (PUSCH) or receiving the PDSCH on the BWP indicated by the PDCCH, selecting the corresponding one or more downlink BWPs according to the configuration information of the downlink BWPs and one or more uplink BWPs transmitting the random access request to monitor the PDCCH for the message in random access and/or receive the PDSCH carrying the message in random access.

Optionally, the configuration information of an initial downlink BWP is obtained, wherein the configuration information of the initial downlink BWP includes one or more control channel resource sets (CORESET) and one or more search spaces for the PDCCH for the preset message, the one or more search spaces corresponds to at least one CORESET among the one or more CORESETs; and the PDCCH for the preset message on the one or more search spaces is monitored according to the configuration information of the initial downlink BWP; wherein the at least one CORESET among the one or more CORESETs is smaller than the bandwidth of the initial downlink BWP, and the bandwidth of the initial downlink BWP is greater than the maximum bandwidth supported by the UE.

Optionally, the monitoring the PDCCH for the preset message on the one or more search spaces includes: adjusting the center frequency position for the UE; receiving downlink data on different CORESETs; and decoding the PDCCH.

Optionally, the selecting one or more downlink BWPs among the multiple downlink BWPs according to the configuration information of the multiple downlink BWPs to monitor the PDCCH for the message in random access and/or receive the PDSCH carrying the message in random access includes at least one of the following: decoding and parsing the PDCCH for the message in random access, and obtaining a field in the PDCCH for the BWP on which the PDSCH carrying the message for random access transmission; determining at least one downlink BWP according to the configuration information of the downlink BWP(s) and BWP information indicated by the field in the PDCCH for the BWP on which the PDSCH carrying the message for random access transmission, receiving and decoding the PDSCH carrying the message in random access on the at least one downlink BWP.

Optionally, an uplink BWP indication for transmitting the PUSCH is obtained; and the PUSCH on the uplink BWP is transmitted according to the uplink BWP indication.

Optionally, the obtaining the uplink BWP indication for transmitting the PUSCH includes at least one of the following: obtaining the uplink BWP indication for transmitting the PUSCH from the random access response (RAR) or MsgB; inferring the uplink BWP indication for transmitting the PUSCH according to the BWP for the PDSCH; and determining the uplink BWP indication for transmitting the PUSCH according to the BWP on which transmitting the random access request.

Optionally, Msg2 is a random access response (RAR).

In particular, the base station may configure in one of multiple BWPs or multiple carriers to receive and/or transmit predetermined messages. Alternatively, multiple BWPs may be further configured on one or more carriers of multiple carriers to receive and/or transmit predetermined messages. In addition, the base station may configure one or more corresponding uplink carriers for one downlink carrier. Alternatively, multiple downlink carriers may correspond to the same one or several uplink carriers. The UE may transmit or receive data on specific one or more of uplink or downlink carrier(s) based on through direct or indirect configuration from the base station, or according to a predefined rule.

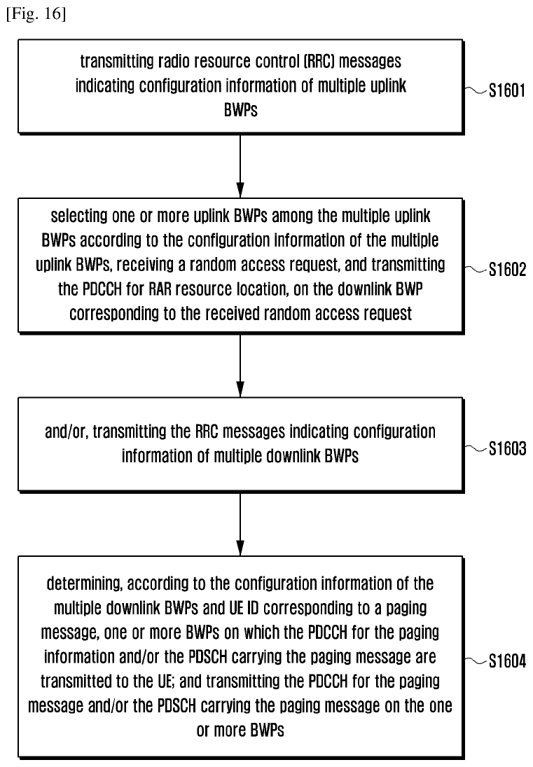

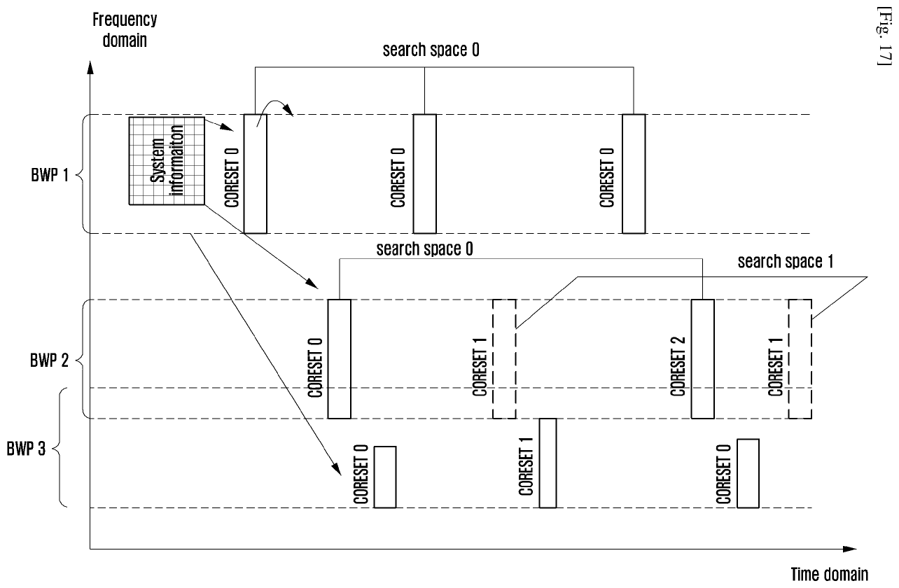

An embodiment of the present disclosure provides another method for data transmission, which is applied to a base station. A schematic flowchart of the method is shown in FIG. 16, and the method includes the following steps.

Step S1601: radio resource control (RRC) messages indicating configuration information of multiple uplink BWPs is transmitted.

Step S1602: one or more uplink BWPs are selected among the multiple uplink BWPs according to the configuration information of the multiple uplink BWPs to receive a random access request, and the PDCCH for RAR resource location is transmitted on the downlink BWP corresponding to the received random access request.

Step S1603, and/or, the RRC messages indicating configuration information of multiple downlink BWPs is transmitted.

Step S1604: one or more BWPs on which the PDCCH for the paging information and/or the PDSCH carrying the paging message are transmitted to the UE are determined according to the configuration information of the multiple downlink BWPs and UE ID corresponding to a paging message; the PDCCH for the paging message and/or the PDSCH carrying the paging message are transmitted on the one or more BWPs.

The technical solutions provided in the embodiments of the present disclosure have at least the following beneficial effects of reducing loads of an initial BWP or Pcell and increasing the number of accessed users of multiple cells.

The above embodiments of the present disclosure are comprehensively and thoroughly explained by the following embodiments.

Optionally, the configuration information of the uplink BWP or the configuration information of the downlink BWP(s) is obtained through system information or a UE specific RRC message, or the configuration information of the uplink BWP or the downlink BWP is specified in the protocol in advance. Specifically, the system message is a system message 1 (SIB1) or a MIB.

Optionally, the preset message includes at least one of the following: a paging message, system information, and a message in random access.

Optionally, the message in random access includes at least one of the following: a random access response (RAR), a message MsgB, a message Msg3, a message MsgA, and a contention resolution message (Msg4). The above message includes initial transmission or retransmission.

In NR, except for downlink semi-persistent scheduling (SPS), time-frequency resource information, modulation and demodulation information, coding block size information, and DMRS information of the PDSCH are all scheduled through the PDCCH. However, in order to save downlink overhead, the information needed to decode the PDSCH can be pre-configured (for example, through RRC messages such as system information) or pre-defined in the protocol (for example, the modulation mode is defined as QPSK), or a combination of pre-configured method with pre-defined method. This allows the UE to directly detect the PDSCH without detecting the PDCCH. Especially for system information, its transmission block size is relatively stable. The base station can directly configure the resource location and transmission block size required to carry other system information through SIB1, similar to the manner of configuring the other system information. For the paging message, since the size of the paging message is fixed, the paging information can be configured by a pre-defined method or, for example, a method of introducing a downlink SPS in a disconnected state. Similarly, for the random access preset message, because the message size is relatively fixed, some information for PDSCH decoding can be pre-defined or configured, and the UE can directly monitor (try to decode) the PDSCH carrying the message in random access on the time-frequency resources.

In addition, in order to provide a certain degree of flexibility, some parameters can be defined or configured with a plurality of values, and the UE detects PDSCH in a busy detection manner. For example, a PDSCH search space may be defined, or several PDSCH formats (such as a transport block size (TBS)) may be defined in advance.

Optionally, the configuration information of the uplink BWP and the configuration information of the downlink BWP(s) include at least one of the following information: the frequency domain position of any BWP, the corresponding uplink configuration and/or downlink configuration of any BWP, the mapping relationship between one or more uplink BWPs and one or more downlink BWPs, and one or more uplink BWPs on a supplementary uplink (SUL) carrier.

The multiple uplink BWPs include one anchor uplink BWP and one or more non-anchor uplink BWPs, and/or the multiple downlink BWPs include one anchor downlink BWP and one or more non-anchor downlink BWPs. The anchor BWP may be an initial BWP or a default BWP of some or all of UEs. The initial BWP or default BWP of different UEs may be the same or different. For example, the initial BWP or default BWP of the UE may be at least one of the following: an anchor BWP, or an uplink BWP that transmits a random access request, and a downlink BWP corresponding to the PDCCH that monitors the scheduling Msg2 or MsgB, the BWP corresponding to CORSET0, the BWP where MIB or SIB is located.

Optionally, the downlink configuration corresponding to any one of the multiple BWPs includes at least one of the following: one or more search spaces for the RAR on the BWP, one or more search spaces for paging, and one or more search spaces for system information 1 (SIB1), and/or a search space for other system information, one or more control resource set (CORESET), and downlink shared channel (PDSCH) configuration, the subcarrier spacing of the downlink BWP, the frequency domain position information of the downlink BWP, and the bandwidth of the downlink BWP.

Optionally, the uplink configuration corresponding to any one of the multiple BWPs includes at least one of the following: random access channel (PRACH) configuration, random access configuration, uplink shared channel (PUSCH) configuration, uplink control channel (PUCCH) configuration, the subcarrier spacing of the uplink BWP, the waveform used by the uplink BWP, the frequency domain position information of the uplink BWP, and the bandwidth of the uplink BWP.

Optionally, the UE monitors a downlink control channel for indicating a preset message and/or receives a PDSCH carrying the preset message in one or more downlink BWPs of the multiple BWPs, including at least one of the following.

The UE selects one or more downlink BWPs among a plurality of BWPs according to a pre-defined rule to monitor a downlink control channel for indicating a preset message and/or receive a PDSCH carrying the preset message.

The UE determines a BWP according to a BWP indication in the PDCCH to receive a PDSCH carrying a preset message.

The UE determines one or more downlink BWPs according to the instructions in the system information, to monitor a downlink control channel for indicating a preset message and/or receive a PDSCH carrying the preset message.

Optionally, as shown in FIG. 17, the UE obtains indication information of multiple BWPs (BWP1, BWP2, BWP3) through system information. The indication information includes one or more search spaces for the RAR on the BWP, one or more search spaces for paging, one or more search spaces for other system information on the BWP, one or more control resource sets (CORESET), one or more downlink shared channel (PDSCH) configuration, and so on. The multiple BWPs may be partially or completely overlapped or non-overlapped in the frequency domain. As shown in FIG. 17, the UE obtains three BWP1-BWP3 configuration information. The BWP1-BWP3 configuration information includes uplink BWP configuration information or downlink BWP configuration information, wherein BWP1 and BWP2, and BWP1 and BWP3 are not overlapped, but BWP2 and BWP3 are partially overlapped. In addition, parameters required for paging, such as nAndPagingFrameOffset, firstPDCCH-MonitoringOccasionOfPO, ns, can be configured for each BWP respectively.

The UE obtains CORESET0 on BWP1, CORESET0 and CORESETI on BWP2, and CORESET0 and CORESETI on BWP3. The bandwidth of the BWP may be the bandwidth of the CORESET, or the bandwidth of the BWP may be greater than the bandwidth of the CORESET. As shown in FIG. 17, the bandwidth of CORESET0 on BWP3 is smaller than the bandwidth of BWP3.

Optionally, the UE also obtains one or more search spaces on each BWP. For example, there are search space 0 and search space 1 on BWP2. The base station can configure the use of the response for each search space, for example, search space 1 on BWP2 is used for paging, and search space 0 on BWP2 is used for random access. If no additional search space is configured, a default search space (for example, SearchSpaceld=0) can be defined in advance to monitor all usages or PDCCHs which are not configured with search spaces.

Since the UE's RF bandwidth cannot be transmitted or received on multiple BWPs simultaneously, the UE only monitors the downlink control channel at one frequency domain position at the same time. However, the UE may monitor more downlink control channels at different times on multiple BWPs. For example, as shown in FIG. 17, if the base station configures the UE to monitor on two BWPs, the UE can monitor the resources allocated to the first cycle of search space 0 on BWP1 and then adjust the center frequency to receive the resources for the first cycle of the search space 0 on BWP2. Subsequently, the UE continues to adjust the center frequency to monitor the second cycle of the search space 0 on BWP1, and so on. Similarly, the UE transmits a random access request only once at the same time. However, the UE can monitor more downlink control channels or transmit multiple random access requests at different times on multiple BWPs.

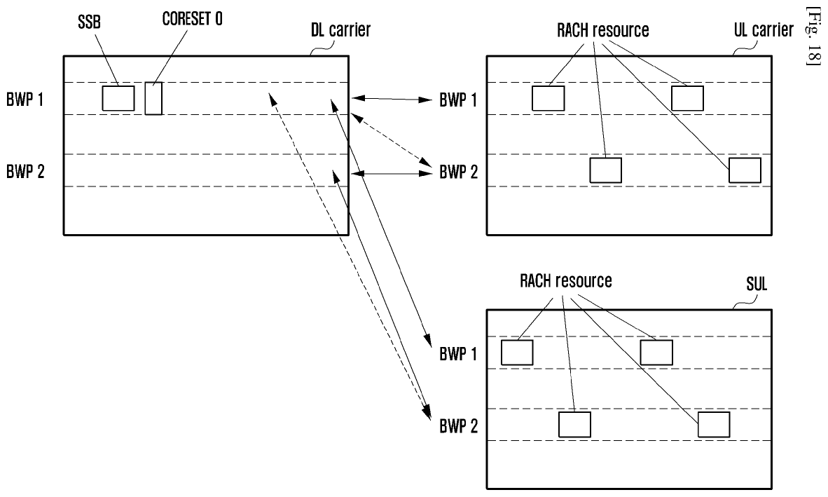

Optionally, the UE can obtain the frequency domain position of each BWP and its downlink configuration and downlink configuration through the configuration information of the uplink BWP and the configuration information of the downlink BWP(s). As shown in FIG. 18, the base station configures BWP1 and BWP2 on the uplink carrier and BWP1 and BWP2 on the downlink carrier in the configuration information of the uplink BWP and the configuration information of the downlink BWP(s). In a TDD system, the uplink carrier and the downlink carrier are the same. In addition, the base station may additionally configure an uplink supplementary (SUL) carrier and one or more BWPs on the SUL (such as BWP1 and/or BWP2 in FIG. 18). In addition, the base station can also configure the mapping relationship between uplink and downlink BWP to the UE. The mapping relationship may be a one-to-one relationship between one uplink BWP and one downlink BWP of the UE. As shown in FIG. 18, uplink BWP1 corresponds to downlink BWP1, and uplink BWP2 corresponds to downlink BWP2. Alternatively, multiple uplink BWPs may correspond to one downlink BWP. As shown in FIG. 18, uplink BWP1 and BWP2 correspond to downlink BWP1. Similarly, multiple downlink BWPs may correspond to the same uplink BWP (not shown in FIG. 18). In addition, in order to ensure uplink coverage, the base station may configure the UE with a supplementary uplink (SUL) carrier and one or more uplink BWPs on the SUL.

Optionally, on multiple downlink BWPs, one anchor downlink BWP and one or more non-anchor downlink BWPs may be configured or obtained according to a preset rule. The anchor BWP can also be referred to as initial BWP or default BWP. As shown in FIG. 18, the downlink anchor BWP may be the downlink BWP1 where CORESET0 is located, which is taken as the anchor BWP. Alternatively, the downlink anchor BWP may be the BWP where the MIB or SIB1 is located. At this time, the anchor BWPs of all UEs are the same, as BWP1 shown in FIG. 18.

Optionally, the anchor BWPs of different UEs may be different. For example, multiple RACH resources are configured on multiple uplink BWPs. The uplink BWP of the UE for random access may be defined as the anchor BWP of the UE. The downlink BWP corresponding to the uplink BWP is the anchor BWP of the UE. For example, UE1 selects BWP1 in FIG. 18 for initial random access, or any one of RACH requests such as RRC resume or one or more pre-defined purposes. For example, for the UE performing initial access or RRCResume, random access from the idle mode or inactive mode takes the BWP corresponding to the random access as the anchor BWP. Then the uplink anchor BWP of the UE1 is BWP1. The downlink anchor BWP is the downlink BWP1 corresponding to the uplink BWP1 selected for the random access, which is the downlink anchor BWP of the UE1. Similarly, if UE2 selects uplink BWP2 for random access, the corresponding downlink BWP2 is the downlink anchor BWP of the UE. If the uplink BWP2 corresponds to the downlink BWP1, the downlink BWP1 is the downlink anchor BWP of the UE2. The SUL is similar to an uplink carrier, it can select the uplink BWP where the RACH resource selected for random access is located as an anchor BWP, and/or the downlink BWP corresponding to the uplink BWP is an anchor BWP. For example, if the UE performs random access on the RACH resource on the BWP1 of the SUL, the BWP1 of the SUL corresponds to the downlink BWP1, which is the downlink anchor BWP of the RRC connection of the UE.

In the NR system, the UE selects UL or SUL for random access according to the channel state of the downlink channel. When multiple BWPs that can be used for random access are configured on UL or SUL, the UE may first select one carrier in UL or SUL according to the rule(s), and then further select one of multiple BWPs in one carrier according to the method(s) described in this disclosure for random access. Alternatively, the UE may first select one of one or more BWPs according to the rule(s) introduced in this disclosure, and then search for an uplink carrier in the UL or SUL related to the BWP for random access.

Optionally, the UE obtains the resource configuration of the random access request on one or more BWPs from the base station. The UE selects a BWP for random access according to a probability that a random access request is transmitted on each BWP defined in advance or configured by the base station.

Optionally, the UE selects one of a plurality of BWPs with equal probability, and selects one of the resources of the BWP random access request for random access, so that the UE is evenly distributed in the plurality of BWPs. For example, the base station configures two BWPs (such as BWP1 and BWP2) on the uplink carrier, and then the UE randomly selects BWP1 or BWP2 for random access with equal probability (50%).

Optionally, the base station may configure for each BWP or a part of multiple BWPs with a probability of randomly selecting the BWP. With this, the base station can control the load on each BWP. For example, the base station configures for an anchor BWP or a BWP1 corresponding to at least one of CORESET0, MIB, and SIB1 with a configuration probability of ¼. At this time, it is applicable to define that there are only two BWPs as shown in FIG. 18, the probability of the UE selecting BWP1 is ¼, and the probability of selecting BWP2 is ¾. The base station can control the load on each BWP by configuring different selection probabilities for different BWPs. For example, for the initial BWP, some downlink resources are needed to transmit SSB, SIB1 and so on, then the BWP may not have enough resources. It may use such a method to effectively reduce the control information and downlink information for retransmission of Msg2/4 or MsgB/Msg3 that need to be transmitted on the BWP. That is, in order to balance the load of some downlink BWPs, each uplink BWP (or uplink BWP having at least resources for random access request) may be configured with a corresponding downlink BWP.

Optionally, since the number of RACH resources allocated on each BWP may be different, the UE may take all the RACH resources on all BWPs as a whole to perform random selection with equal probability. As shown in FIG. 18, there are two BWPs on the uplink carrier, there are two RACH resources on each BWP, and these resources are for TDM. Therefore, the UE can select the nearest RACH resource for random access request according to the arrival time of its service. If the RACH resources of multiple BWPs are for FDM, or partially overlapped, then the UE may first select a BWP through the previous two methods and then select one of the RACH resources on the BWP for random access.

After transmitting an uplink random access request such as Msg1 or MsgA, the UE will monitor the PDCCH for Msg2 or MsgB in the search space of the corresponding downlink BWP. In addition, the UE can also monitor the downlink PDCCH for Msg3 retransmission or MSG4 scheduling on the BWP. For example, as shown in FIG. 18, the UE transmits Msg1 or MsgA on BWP1, and the downlink BWP corresponding to the uplink BWP1 is BWP1, then the UE monitors the downlink control channel for Msg2 or MsgB on the downlink BWP1. If no other BWP is configured for the UE in Msg2 or MsgB, the UE continues to perform monitoring on the downlink BWP1.

If the uplink BWP1 corresponds to multiple downlink BWPs at this time, the UE needs to monitor the downlink channel on multiple downlink BWPs. If the bandwidth of the UE is limited, the UE may select or calculate a downlink BWP for monitoring according to a pre-defined rule. Alternatively, the base station guarantees TDM between search spaces configured on multiple downlink BWPs, and leaves enough time for RF retuning. For example, as shown in FIG. 17, the PDCCH search space 0 on BWP1 and BWP2 is at different times, and the UE can monitor different search spaces in sequence at different times.

Optionally, in order to control the complexity and power consumption of the NR-light UE, the bandwidth of the UE will be reduced. However, since the base station needs to support multiple users, the bandwidth of the base station will be much larger than the bandwidth of the UE. In the design of Rel-15, NR takes into account the purpose of UE power saving, so the concept of BWP is introduced. However, in the NR system of Rel-15, the bandwidth which can be supported by the eMBB UE is far more than that required by the NR-light UE. In order to co-exist eMBB UE and NR-light UE better, and share broadcast information (such as SSB) as fat as possible to reduce resource overhead, it needs to limit the downlink information used for eMBB UE, which is also limited to the bandwidth which is acceptable to the NR-Light UE, this will limit the performance of the eMBB UE. In order to enable the eMBB UE and the NR-Light UE to share some broadcast information (such as SSB), they would be separated as soon as possible in subsequent downlink transmissions to reduce the impact on the performance of the eMBB UE.

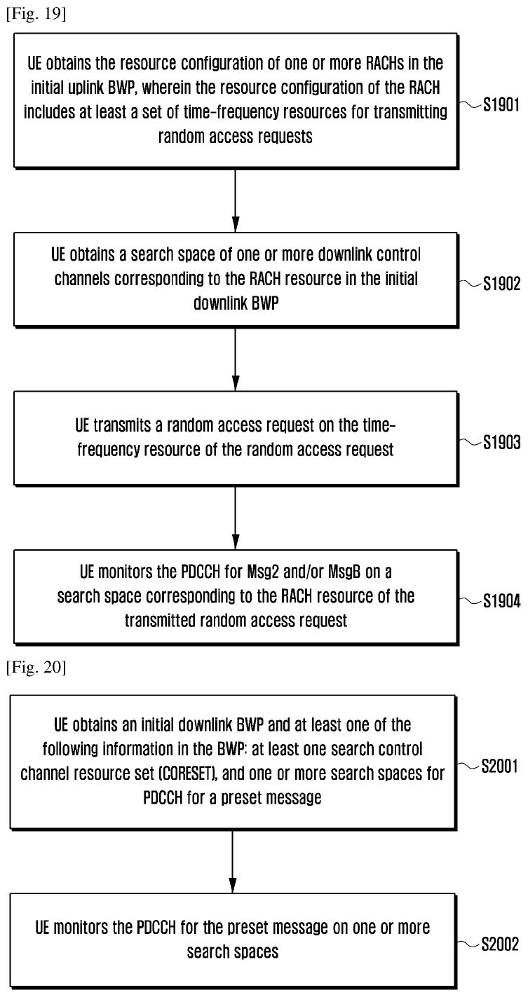

An embodiment of the present disclosure provides another method for data transmission, which is applied to a UE. A schematic flowchart of the method is shown in FIG. 19. The method includes the following steps.

Step S1901: the UE obtains the resource configuration of one or more RACHs in the initial uplink BWP, wherein the resource configuration of the RACH includes at least a set of time-frequency resources for transmitting random access requests.

Step S1902: the UE obtains a search space of one or more downlink control channels corresponding to the RACH resource in the initial downlink BWP.

Step S1903: the UE transmits a random access request on the time-frequency resource of the random access request.

Step S1904: the UE monitors the PDCCH for Msg2 and/or MsgB on a search space corresponding to the RACH resource of the transmitted random access request.

At least one of the CORESETs corresponding to the search space of the one or more downlink control search channels is smaller than the bandwidth of initial downlink BWP.

The CORESET corresponding to the search space of the one or more downlink control search channels is less than or equal to the minimum bandwidth of the UE.

The random access request includes Msg1 or MsgA. For Msg2 or MsgB without PDCCH scheduling, the UE can directly detect the PDSCH carrying Msg2 and/or MsgB on the search space. The above resource configuration is indicated in system information (such as MIB, SIB1, or other system information) or a UE specific RRC message. It can also be defined in the protocol in advance, combined with the indication of the system information or the UE specific RRC message, such as indicating some of these parameters through signaling, or indicating one or more of them.

An embodiment of the present disclosure provides another data transmission method, which is applied to a UE. A schematic flowchart of the method is shown in FIG. 20. The method includes the following steps.

Step S2001: the UE obtains an initial downlink BWP and at least one of the following information in the BWP: at least one search control channel resource set (CORESET), and one or more search spaces for PDCCH for a preset message.

Step S2002: the UE monitors the PDCCH for the preset message on one or more search spaces.

The bandwidth of initial downlink BWP is greater than the maximum bandwidth supported by the UE.

Among the at least one CORESET, the bandwidth spanned by at least one CORESET is less than the bandwidth of initial downlink BWP and less than or equal to the maximum bandwidth supported by the UE.

CORESET may occupy continuous frequency domain resources or discontinuous frequency domain resources. The bandwidth spanned by CORESET includes a range of the lowest frequency to the highest frequency of CORESET.

Optionally, the UE monitoring the PDCCH for the preset message on one or more search spaces further includes that: the UE adjusts the center frequency of the UE, receives downlink data on different CORESETs, and attempts to decode the PDCCH.

Optionally, for a base station supporting a non-NR-Light UE, since the minimum bandwidth supported by the non-NR-Light UE is relatively large, the base station may configure the non-NR-Light UE with a larger BWP for monitoring downlink shared messages. For the NR-Light UE, although the bandwidth of the BWP can be relatively large, the NR-Light UE requires that as long as the bandwidth occupied by CORESET is less than or equal to the minimum bandwidth of the NR-Light UE. Therefore, the CORESET used for NR-Light UE configuration can be smaller than the initial downlink bandwidth. That is, the at least one CORESET among the one or more CORESETs received by the UE is smaller than the initial downlink BWP bandwidth. The initial downlink BWP bandwidth may be greater than the maximum bandwidth supported by the NR-Light UE. When multiple CORESETs are in different frequency domain positions in a downlink bandwidth, if the frequency domain spans of multiple CORESETs are greater than the RF bandwidth of the NR-light UE, the NR-light UE cannot monitor multiple CORESETs simultaneously. For multiple CORESETs at different time positions, the NR-light UE needs to perform RF retuning to monitor candidate PDCCHs on different CORESETs. At this time, a certain interval needs to be reserved between CORESETs that need to be returned, for example, a symbol, or a part of CP. This interval may depend on the reporting capabilities of the UE. For the CORESET of the common channel(s), since the base station does not know the capabilities of the UE, it can only perform the most conservative configuration, that is, meet the maximum value specified in the protocol. If the CORESET configured by the base station does not satisfy the capabilities of the UE, the UE may select to not monitor a candidate PDCCH on a CORESET, or a resource in a partial PDCCH on a CORESET. The base station may transmit a larger aggregation level to ensure PDCCH reception performance. This CORESET which is not monitored by the UE in whole or in part may be specified in advance through the protocol, or configured by the base station, or selected according to the implementation of the UE. The above methods can be widely applied to various PDCCH search spaces, such as at least one of a common search space or a UE-specific search space.

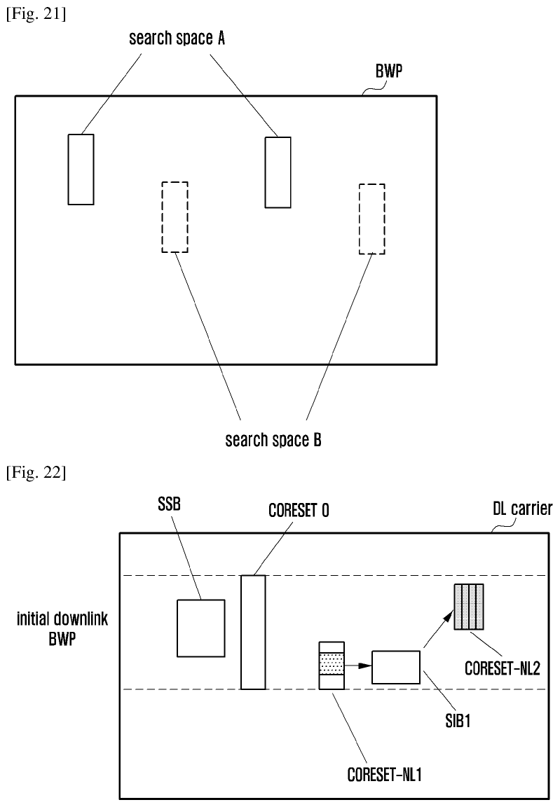

Optionally, the base station configures multiple search spaces and CORESETs for paging or other downlink broadcast messages on one BWP. Each of bandwidths occupied by these search spaces is less than or equal to that of BWP and less than or equal to RF bandwidth of the UE. As shown in FIG. 21, the base station configures a search space A and a search space B for the UE, both of which are used for paging information. However, it is not required that all UEs monitor all of search spaces. In the following embodiments, the base station configures one or more downlink BWPs for the UE, and the methods 1 to 3 for the UE receiving downlink preset messages (such as system messages or paging messages) can be used to determine the sequence number of search spaces monitored by the UE. The number of search spaces can replace Nbwp, and the sequence number of the calculated search space can replace PBWP. Alternatively, the UE needs to monitor all of search spaces, so the base station needs to ensure that enough time is left between different search spaces for the different UEs adjusting the center frequency. Similarly, this method can be used for transmission of system information, downlink PDCCH for random access, and the like.

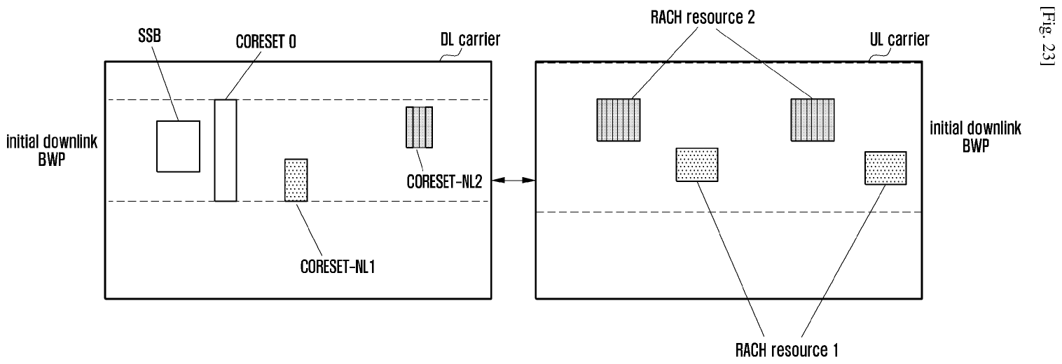

Optionally, as shown in FIG. 22, the UE obtains the initial uplink/downlink BWP configuration and one or more of the following information from the base station: one or more search spaces, and one or more CORESETs. Specifically, the UE receives the SSB, and obtains the configuration of the downlink BWP and the configurations of CORESET0 and search space 0 from the SSB. The downlink BWP is the bandwidth occupied by CORESET0. The UE can further obtain CORESET-NR Light 1 (CORESET-NL1) from the MIB of the SSB, wherein the bandwidth of CORESET-NL1 is smaller than the bandwidth of the initial downlink BWP. CORESET-NR1 can be used for NR-Light UE, then it requires that the bandwidth occupied by CORESET-NL1 is less than or equal to the RF bandwidth of NR-Light UE to ensure that the UE receives downlink transmissions from the base station, such as SIB1, OMSI, paging information, and random access related information. The base station may obtain the search space and/or CORESET for receiving a downlink preset message from SIB1.

Optionally, as shown in FIG. 22, the UE obtains CORESET-NL1 for monitoring the search space of the SIB1 in the SSB, and successfully decodes the SIB1. In SIB1, the UE obtains CORESET-NL2, which is used to indicate where the search space for another specific downlink information is located. One or more additional CORESETs can be configured in SIB1. The specific downlink information may be other system information, paging information, and the like. Then the UE monitors the same or different CORESET according to the configured search space. If the search spaces are different, the UE adjusts the center frequency, receives downlink data on different CORESETs, and attempts to decode the PDCCH.

FIG. 23 shows a method for obtaining an uplink BWP or a downlink BWP. As shown in FIG. 23, the UE obtains the initial uplink BWP configuration and the initial downlink BWP configuration and one or more of the following information from the base station: resource configuration of one or more RACHs, and one or more time-frequency resources for transmitting random access requests, one or more search spaces, one or more CORESETs.

Specifically, the UE receives the SSB, and obtains the configuration of the downlink BWP and the configurations of CORESET0 and search space 0 from the SSB. The initial downlink BWP bandwidth is the bandwidth occupied by CORESET0. The UE can further obtain CORESET-NR Light 1 (CORESET-NL1) from the MIB of the SSB, wherein the bandwidth of CORESET-NL1 is smaller than the bandwidth of the initial downlink BWP. CORESET-NR1 can be used for NR-Light UE, so it requires that the bandwidth occupied by CORESET-NR1 is less than or equal to the RF bandwidth of NR-Light UE to ensure that the UE obtains the RACH configuration and other uplink configuration from the base station. Here, CORESET-NL1 may be the initial downlink BWP bandwidth of the NR-Light UE, which is different from the initial bandwidth of the system (another UE) (the bandwidth of CORESET0).

Optionally, the RACH resource 1 (or the random access resource 1 corresponding to the RACH configuration 1) corresponds to the search space NL 1 using CORESET-NL1. The bandwidth occupied by RACH resource 1 is less than or equal to the RF bandwidth of the UE, such as the bandwidth of the NR-light UE. The UE selects a time-frequency resource on a RACH1 resource to transmit a random access request. Subsequently, the UE monitors the PDCCH for Msg2/MsgA on a search space corresponding to the random access request (and/or a CORESET resource corresponding to the search space).

Optionally, the corresponding methods of the RACH resource and the PDCCH search space include the following methods.

Method 1: the base station configures a set of RACH resources and multiple sets of search spaces to the UE.

As shown in FIG. 23, the UE monitors the PDCCH on the search space NL1 using CORESET-NL1. In addition, a RACH resource may correspond to multiple search spaces and/or CORESET. As shown in FIG. 23, RACH resource 1 corresponds to the search space NL1 using CORESET-NL1 and the search space NL2 using CORESET-NL2. CORESET-NL1 and CORESET-NL2 are for TDM, so the UE with limited bandwidth can retune the center frequency at different times so that it can accept monitoring the PDCCH on the CORESET at that time. This configuration can bring diversity gain, especially when the candidate PDCCH in one search space would span the CORESET among multiple different frequency domain resources. For example, one candidate PDCCH repeats on different CORESETs and/or search spaces. This method can obtain diversity gain.

Method 2: the base station configures multiple sets of RACH resources and the corresponding multiple sets of search spaces to the UE.

Optionally, the base station may configure multiple RACH resources for the UE, as shown in FIG. 23, such as RACH resource 1 and RACH resource 2. Each RACH resource corresponds to a search space of a PDCCH for random access, for example, RACH resource 1 corresponds to a search space NL1 using CORESET-NL1, and RACH resource 2 corresponds to a search space NL2 using CORESET-NL2. After the UE selects one of the RACH resources to transmit a random access request, it monitors the PDCCH for random access on its corresponding search space. For each set of RACH resources, the base station can configure multiple sets of search spaces corresponding to them. This can obtain diversity gain.

Optionally, the base station may further configure multiple sets of RACH resources and a corresponding set of search spaces to the UE.

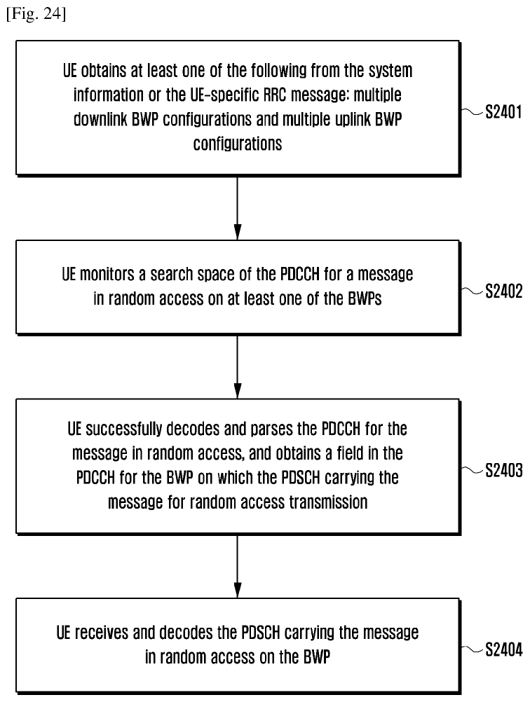

An embodiment of the present disclosure provides another data transmission method, which is applied to a UE. A schematic flowchart of the method is shown in FIG. 24, and the method includes the following steps.

Step S2401: the UE obtains at least one of the following from the system information or the UEspecific RRC message: multiple downlink BWP configurations and multiple uplink BWP configurations.

Step S2402: the UE monitors a search space of the PDCCH for a message in random access on at least one of the BWPs.

Step S2403: the UE successfully decodes and parses the PDCCH for the message in random access, and obtains a field in the PDCCH for the BWP on which the PDSCH carrying the message for random access transmission.

Step S2404: the UE receives and decodes the PDSCH carrying the message in random access on the BWP. Optionally, the UE obtains a BWP indication for transmitting an uplink PUSCH; the UE transmits the PUSCH on the uplink BWP.

The UE obtains the BWP indication for transmitting the uplink PUSCH in Msg2 or MsgB, or the UE infers the BWP indication for transmitting the uplink PUSCH according to the BWP for the PDSCH, or the UE determines the BWP indication for transmitting the uplink PUSCH according to the BWP for the random access request.

The uplink PUSCH is used to carry Msg3 or other uplink information.

The BWP indication for transmitting the uplink PUSCH is indicated in the MAC header or the MAC RAR. Specifically, the BWP is indicated in an uplink grant (UL grant) in the MAC RAR.

Optionally, after the UE obtains a specific RACH configuration and transmits a random access request on the resources for the specific configuration, it monitors the downlink search space for Msg2/MsgB with the specific RACH configuration.

The UE monitors the downlink search space for Msg2/MsgB on at least one of the BWPs, which further includes that: the UE monitors the PDCCH in a specific format on the downlink search space, wherein the PDCCH in the specific format includes a BWP indicator domain.

Optionally, retransmission of PUSCH carrying Msg3 or MsgA or the BWP in which the search space for PDCCH subsequently uplink and downlink scheduling of Msg4 or MsgB is located is indicated in Msg2/MsgB.

Optionally, after transmitting the uplink PUSCH or receiving the PDSCH, the UE returns the at least one of the BWPs, and continues to monitor the downlink search space for messages used for random access on the BWP.

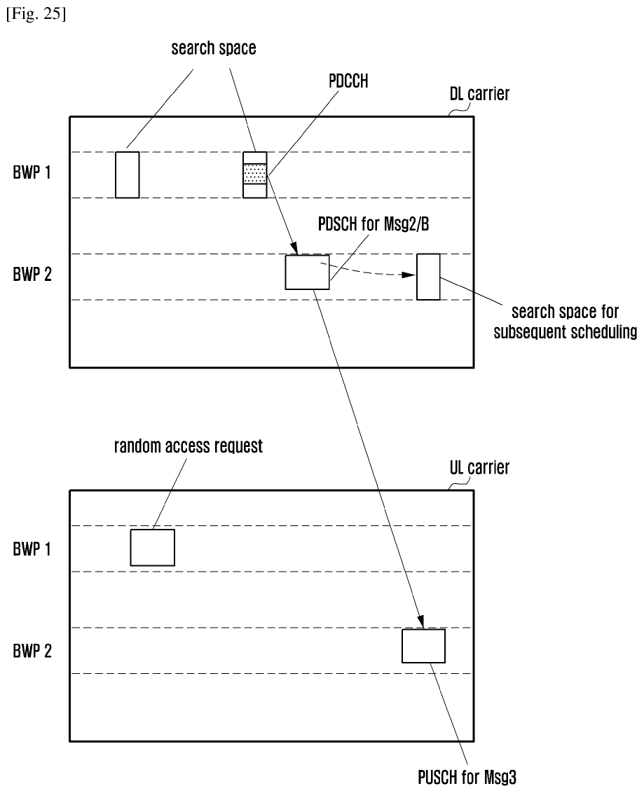

Optionally, as shown in FIG. 25, the UE obtains configurations of two downlink BWPs (downlink BWP1 and downlink BWP2) and configurations of two uplink BWPs (uplink BWP1 and uplink BWP2) from the system information. According to the configurations, the UE monitors and successfully decodes the PDCCH on the search space for Msg2/MsgB. The UE determines the BWP where the PDSCH carrying Msg2/MsgB is located and the time-frequency resource location used for PDSCH receiving decoded information according to the indication in the PDCCH. In particular, downlink BWP1 and downlink BWP2 may be in the same or different frequency domain positions. In addition, for NR-Light UE with a limited bandwidth, it requires that the RF center frequency is adjusted through RF retuning to receive the PDSCH in BWP2. In order to leave enough time, the base station needs to ensure that the PDSCH scheduling delay is sufficient for RF retuning.

Optionally, since the PDCCH for the RAR does not include the BWP indication domain in the existing NR UE, the base station needs to know whether the UE currently performing a random access request supports a new BWP field. The base station can configure specific RACH resources (such as time domain, frequency domain, code domain, specific RACH occasions, etc.) for the UE. If the UE parses a PDCCH in a specific format that includes a BWP indication domain, the specific RACH resource is selected for a random access request. Then, the base station may select an appropriate PDCCH format to indicate RAR or MsgB according to the detected random access request. The size of a specific PDCCH may be different from that of other PDCCHs indicating RAR. Therefore, the base station can use the same RNTI to transmit two PDCCHs respectively in the same search space. Alternatively, the PDCCH sizes may be the same (for example, the number of bits allocated in the PDSCH frequency domain resource may be reduced, and the BWP indication domain may be increased), different RNTIs may be used, or different search spaces may be configured (on the same or different BWPs). However, a relative flexible method is that the base station configures two sets of parameters for PDCCH monitoring independently. The two sets of parameters can be the same or different. Alternatively, some of parameters are the same and some of parameters are different (for example, different CORESET resources, etc.). In particular, the frequency domain resources occupied by the CORESET among a specific PDCCH may be smaller than the bandwidth of the initial BWP.

Optionally, in the PDSCH, the UE obtains a BWP for subsequent PUSCH transmission(s) for example, a BWP indication domain in a UL grant in a MAC RAR. Because the bandwidth of the NR-light UE is limited, the frequency domain resources of the PUSCH do not need the original 14 bits. According to the bandwidth of the NR-light UE, it can be reduced to 12 or less bits. Then the saved bits can be used to indicate the BWP, that is, the introduced indication domain of the BWP, for example, 2 bits indicate a maximum of 4 possible BWPs.

As shown in the foregoing, when selecting specific RACH resources for random access, it may use the new method to parse RAR grants, while old RACH resources may be parsed by using the original number of bits. Alternatively, a RAR header or a reserved bit (R) in the RAR may be used to indicate which of the two is used. Alternatively, different uplink grant domains may be parsed according to the format of the PDCCH for the RAR, the search space, the CORESET resource, and the like. It can also add a new byte in the MAC RAR to indicate the BWP. The number of authorized bits in the random access response is shown in Table 1.

Optionally, the base station may configure the mapping relationship between uplink BWP and downlink BWP for the UE, or the mapping relationship between uplink BWP and downlink BWP is fixed in the protocol in advance, and then the UE can infer the BWP for transmitting the uplink PUSCH according to the BWP of the PDSCH. Alternatively, the base station may configure the BWP for transmitting the uplink PUSCH or determine the BWP for transmitting the uplink PUSCH according to the BWP on which transmitting a random access request pre-specified in protocol. For example, it is the same as the BWP that transmits the random access request. Table 3 describes numbers of authorized bits in the random access response.

TABLE 3

| | Original number | New number |
|---|---|---|
| RAR grant domain | of bits | of bits |
| Frequency domain FM | 1 | 1 |
| (frequency modulation) flag | | |
| BWP indication for | — | 2 |
| transmitting PUSCH | | |
| PUSCH frequency domain | 14 | 12(or 10) |
| resource allocation | | |
| PUSCH time domain | 4 | 4 |
| resource allocation | | |
| modulation and coding | 4 | 4 |
| scheme (MCS) | | |
| TPC instruction for PUSCH | 3 | 3 |
| channel states information | 1 | 1 |
| (CSI) request | | |
| Retransmission of Msg3 or | — | (2) |
| BWP of Msg4 or search | | |
| space for PDCCH | | |

Optionally, in the RAR or MsgB, the base station may configure the UE with the retransmission of PUSCH carrying Msg3 or MsgA or the BWP in which the search space for PDCCH subsequently uplink and downlink scheduling of Msg4 or MsgB is located. As shown in FIG. 25, the base station configures the search space used for subsequent scheduling in the PDSCH for the UE, the BWP in which the searched space is located is BWP2. With this, the offload to the UE can be completed in RAR or MsgB. Specifically, as shown in Table 1, a domain for indicating the retransmission of Msg3 or BWP of Msg2 or search space for the PDCCH may be added. For example, this domain may use a 2-bit indicator, and the uplink grant bit may be kept unchanged by further compressing the domain allocated by the PUSCH frequency domain resource.

The base station configures one or more downlink BWPs to the UE, and the methods for the UE receiving a downlink preset message (for example, a system message or a paging message) are as follows.

The following method is also applicable by replacing multiple BWPs with multiple carriers.

Method 1: the UE selects one or more downlink BWPs among multiple BWPs according to a pre-defined rule, monitors a downlink control channel for indicating a preset message and/or receives a PDSCH carrying the preset message. Specifically, the method for receiving paging information may include the following two methods.

Method A: the UE selects one or more downlink BWPs among multiple BWPs according to the UE ID, monitors a downlink control channel for indicating a paging message and/or receives a PDSCH carrying the paging message.

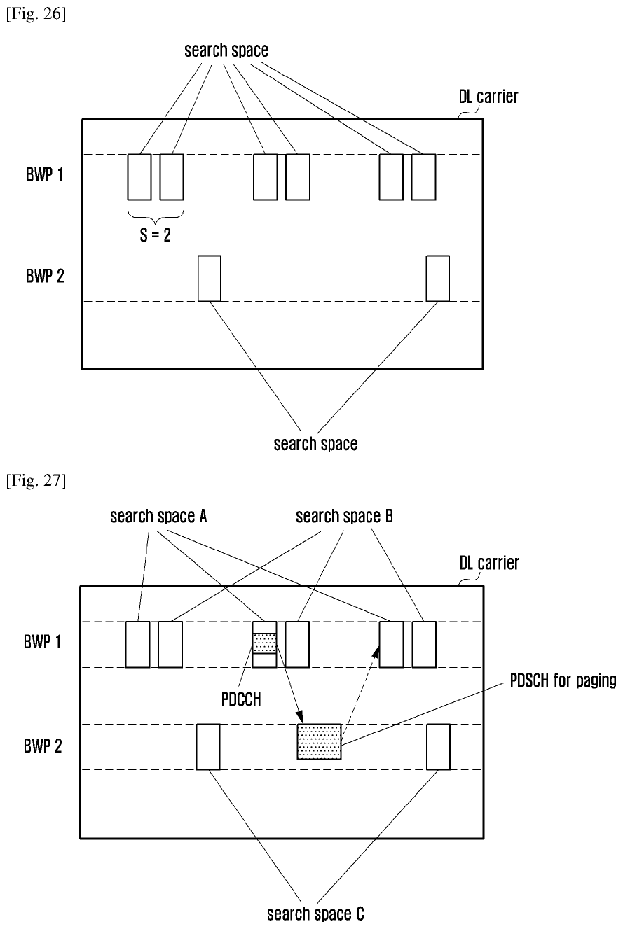

As shown in FIG. 26, the base station configures two BWPs of BWP1 and BWP2 to the UE, and paging information is configured for the two BWPs, respectively. In FIG. 26, the paging cycle is different between BWP1 and BWP2. In another example, the paging cycles of all BWPs are configured to be the same. In addition, in FIG. 26, a specific search space is configured for the UE in BWP1, for example, a SearchSpaceId other than 0 is configured for pagingSearchSpace. The UE monitors the (i_s+1)^{th} P. The PO is a set of “S” consecutive PDCCH monitoring occasions, wherein “S” is the number of SSBs actually transmitted determined according to ssb-PositionsInBurst in SIB1. In BWP1, the SSB is transmitted twice, so S=2. However, in BWP2, it can configure different numbers of SSBs for BWP2. For example, BWP2 can also transmit an SSB, which can only be used for measurement without having to meet the requirements of a synchronous grid. Then, S in BWP2 may be determined according to the actual number of SSB transmissions in BWP2. As shown in FIG. 26, the number of SSBs in BWP2 is 1, then UE has only one monitoring occasion per PO.

If the base station configures the UE with multiple BWPs for paging information, the UE determines the location of the BWP through formula (3):

PBWP=floor(UE_ID/(N*Ns))mod Nbwp (3)

wherein N: the number of paging frames in a DRX cycle;

Ns: the number of paging occasions of a PF;

Nbwp: the number of paging BWP;

UE_ID: 5G-S-TMSI mod 1024.

This method may enable UEs that support paging on multiple BWPs evenly distributed on different BWPs.

According to the UE_ID that needs to be paged, the base station may determine the BWP for transmitting the user's paging message through the above formula, and transmit the PDCCH for the paging message and/or the paging message.

Since there may have users of Rel-15 in the current system that do not support this paging method, the base station may store the UE's capacity to the core network or the base station itself. If it cannot obtain whether the UE has the capacity of supporting multiple BWP paging, the base station may transmit paging information on the initial BWP and the BWP calculated according to the above method, respectively. This method is also applicable to other methods of transmitting paging herein.

In order to reduce the load on the initial BWP, the base station may indicate to the UE that supports paging on multiple BWPs whether the initial BWP participates in the calculation of the PBWP. The base station may make indication through a new information element (IE), or if an additional search space is configured for the initial BWP, the initial BWP may be included in the calculation of the BWP, otherwise it cannot monitor on the initial BWP.

Method B: the UE selects one or more downlink BWPs according to the paging weight corresponding to each BWP configured by the base station, monitors a downlink control channel for indicating a paging message and/or receives PDSCH carrying a paging message.

Since there may have users of Rel-15 in the current system that do not support the new paging method, in order to avoid supporting too many users on the initial BWP (or anchor BWP), it may configure paging weight for each BWP.

Then, the UE may monitor the paging BWP which satisfies the smallest n in the following formula (4):

floor(UE_ID/(N*Ns))mod W<W(0)+W(1)+ . . . +W(n) (4)

wherein W (i) is the weight on BWPi, which is configured in the broadcast message through RRC, and W is the sum of the weights of all paging carriers, that is, W=W (0)+W (1)+ . . . +W (Nbwp−1), Nbwp is the number of paging BWP.

In addition, for method B, the base station may configure the weight of some BWPs (such as the initial BWP) as 0, which means that a UE that supports monitoring of paging on multiple BWPs will not monitor paging information on the initial BWP. In the case that most UEs do not support monitoring paging on multiple BWPs, this can very effectively avoid the load in the initial BWP.

Method 2: the UE determines a BWP according to the BWP indication in the PDCCH to receive a PDSCH carrying a preset message.

In the system information, the base station may configure multiple BWPs of the downlink PDSCH for receiving a preset message. On one or more BWPs among the multiple BWPs, the base station configures a search space that needs to be monitored by the UE. Different search spaces may be configured for PDSCHs carrying different information. The different search spaces include search spaces on the same or different BWPs.

As shown in FIG. 27, the base station configures two BWPs for the UE: BWP1 and BWP2. The base station only configures two search spaces for the UE on BWP1, wherein search space A is used to monitor other system information, and search space B is used to monitor paging. According to the base station configuration, the UE determines that there is a BWP transition domain in the PDCCH monitored on search space A and/or search space B, wherein one state (such as 0) indicates that the PDSCH is on BWP1 and the other state (such as 1) indicates that PDSCH is on BWP2. If multiple BWPs are configured, more bits may be used for indication, for example, 2 bits indicate 4 BWPs. Specifically, as shown in FIG. 27, the UE detects the PDCCH in the search space A, wherein the BWP field is indicated as 1, which means that its PDSCH is transmitted on BWP2.

In the connected state, the base station indicates the switching of the BWP through the PDCCH, but for the non-connected state or for the reception of paging or system information, after receiving the PDSCH, the UE may return to the original BWP and continue to monitor the search space of the response. Alternatively, after receiving the switching of BWP, the UE monitors the search space of the response on the new BWP. Alternatively, if the new BWP is not configured with a search space for a preset message, the UE returns to the original BWP to perform monitoring, otherwise it stays on the new BWP to perform monitoring. Alternatively, only after the PDSCH is successfully decoded, it continues to monitor on the new BWP, otherwise it returns to the original BWP to monitor the search space.

As shown in FIG. 27, after the BWP2 decodes the PDSCH, the UE returns to the BWP1 to continue to monitor the search space A and the search space B. For broadcast channels such as paging channels or system information, since it does not involve interaction with the UE, and it is broadcast or multicast to multiple users, it can effectively avoid information asymmetry with the base station after the UE decodes the PDSCH and returns to the original BWP for monitoring. For example, if the UE does not successfully decode the PDCCH on BWP1, because there is no feedback channel, the base station does not know that the UE does not successfully decode the PDCCH, so the base station will continue to transmit on the search space C of BWP2, and the UE continues to monitor the search space on BWP1.

Method 3: the UE determines one or more downlink BWPs according to the indication in the system information, monitors a downlink control channel for indicating a preset message and/or receives a PDSCH carrying the preset message.

The base station configures multiple BWPs for the UE, but only some BWPs have a search space for preset messages. Furthermore, the UE needs to monitor all or part of the search spaces according to requirements. As shown in FIG. 27, search space A is configured on BWP1 for paging, search space B is used for system information, and search space C is configured on BWP2 for paging. In contrast to the method 1, the base station is configured with two BWPs for paging, and the UE needs to monitor the search space on the two BWPs. If the bandwidth of target UE is limited, the base station needs to ensure that enough time is left between different search spaces on the different BWPs for the UE adjusting the RF center frequency. As shown in FIG. 27, the UE monitors the search space A for paging on BWP1, and the UE monitors the search space C for paging on BWP2. The search space A and the search space C are at different times.

The base station can configure different offsets for different BWPs to ensure that the UE can monitor the PDCCH on multiple BWPs. Alternatively, the base station may configure the same DRX cycle for paging, however, the BWP where the paging cycle is located is determined according to a system frame number (SFN). For example, the following formula (5) is used to calculate the BWP where each cycle is located:

PBWP=((SFN+PF_offset)mod T)mod Nbwp (5)

Nbwp: the number of paging BWP

T: DRX cycle of UE (T is determined by the shortest of the UE specific DRX value(s), if configured by RRC or upper layer, and a default DRX value broadcast in the system information. In RRC_IDLE state, if UE specific DRX is not configured by RRC or upper layer, the default value is applied.)

PF_offset: offset used for PF determination

Similarly, the BWP is determined according to the sequence number of each paging frame. For example:

PBWP=PF_index mod Nbwp

wherein PF_index is the sequence number of the paging frame starting from SFN 0.

Alternatively, it is determined which BWP is based on the sequence number of each paging cycle. For example:

PBWP=PO_index mod Nbwp

wherein PO_index is the sequence number of the paging frame starting from the first paging cycle of SFN 0

Alternatively, when S>1, different search spaces are on different BWPs.

The above method can effectively reduce the load of paging on the initial BWP or Pcell. In addition, different diversity gains can be obtained. Especially for the reception of system information that can be combined, the PDSCH carrying system information in a modification period can be combined. If the PDSCH is transmitted on different BWP, a frequency diversity gain can be obtained.

The base station may configure information of multiple carriers in SIB1 or other SIBs to the UE. For example, additional information about other carriers and/or carrier groups is added to the ServingCellConfigCommonSIB information element (IE) in SIB1. Specifically, for example, an element for configuring other carrier information is added to the ServingCellConfigCommonSIB information, such as one or more of ScelldownlinkConfigCommon, ScelluplinkConfigCommon, ScellsupplementaryUplink, and so on.

ServingCellConfigCommonSIB information element

```
  -- ASN1START
  -- TAG-SERVINGCELLCONFIGCOMMONSIB-START
  ServingCellConfigCommonSIB ::= SEQUENCE {
```

| | |
|---|---|
| downlinkConfigCommon | DownlinkConfigCommonSIB, |
| ScelldownlinkConfigCommon | DownlinkConfigCommonSIB, |
| uplinkConfigCommon | UplinkConfigCommonSIB |

OPTIONAL, -- Need R

| | |
|---|---|
| supplementaryUplink | UplinkConfigCommonSIB |

OPTIONAL, -- Need R

| | |
|---|---|
| ScelluplinkConfigCommon | UplinkConfigCommonSIB |

OPTIONAL, -- Need R

| | |
|---|---|
| ScellsupplementaryUplink | UplinkConfigCommonSIB |

OPTIONAL, -- Need R

| | |
|---|---|
| n-TimingAdvanceOffset | ENUMERATED { n0, n25600, |
| n39936 } | OPTIONAL, -- Need S |
| ssb-PositionsInBurst | SEQUENCE { |
| inOneGroup | BIT STRING (SIZE (8)), |
| groupPresence | BIT STRING (SIZE (8)) |

OPTIONAL -- Cond FR2-Only
},

| | |
|---|---|
| ssb-PeriodicityServingCell | ENUMERATED {ms5, ms10, |

ms20, ms40, ms80, ms160},
tdd-UL-DL-ConfigurationCommon TDD-UL-DL-ConfigCommon
OPTIONAL, -- Cond TDD

| | |
|---|---|
| ss-PBCH-BlockPower | INTEGER (−60..50), |

```
    ...
  }
  -- TAG-SERVINGCELLCONFIGCOMMONSIB-STOP
  -- ASN1STOP
```

Optionally, the base station supports legacy UEs and NR-Light UEs with a smaller maximum bandwidth. The following methods may be included.

Method 1: the initial BWP is configured to be less than or equal to the maximum bandwidth of the NR-Light UE, so that the legacy UE and the NR-Light UE have the same initial BWP.

At this time, since the bandwidth of the initial BWP is small, multiple BWPs are introduced to perform paging, random access response, and system information transmission to reduce the load on the initial BWP. In addition, it may also support BWP switching before establishing a connection.

Method 2: the initial BWP bandwidth of the system may be greater than the maximum bandwidth of the NR-Light UE, but one or more additional CORESET-NL are configured for the NR-light UE, wherein the expanded bandwidth of the CORESET-NL is less than or equal to the bandwidth of the NR-Light UE. Then, the NR-Light UE monitors one or more search spaces according to CORESET-NL, which is used for paging, broadcast, random access, and subsequent monitoring of UE specific PDCCHs.

The above method can be applied to NR-Light UE or new eMBB or URLLC UE that supports this method.

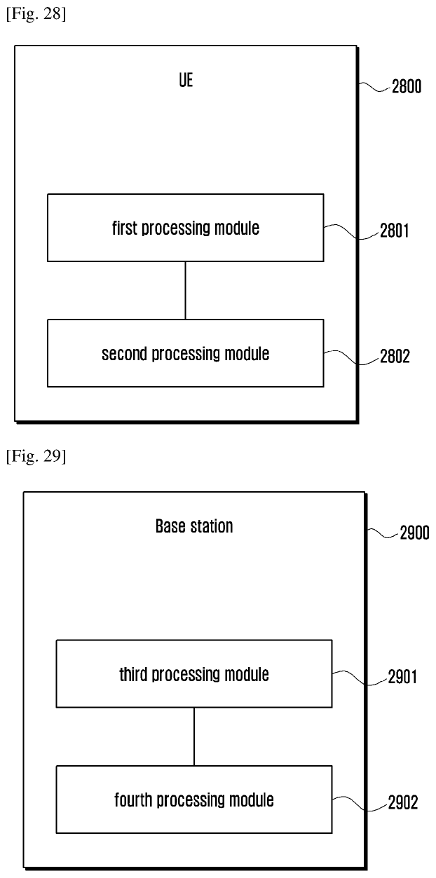

Based on the same inventive concept of Embodiment 3, an embodiment of the present disclosure further provides a UE. A schematic structural diagram of the UE is shown in FIG. 28. The UE 2800 includes a first processing module 2801 and a second processing module 2802.

The first processing module 2801 is configured to obtain configuration information of multiple uplink bandwidth blocks (BWPs); the second processing module 2802 is configured to select one or more uplink BWPs among the multiple uplink BWPs according to the configuration information of the uplink BWPs, and transmit a random access request. Alternatively/additional, the first processing module 2801 is configured to obtain configuration information of multiple downlink BWPs; the second processing module 2802 is configured to select one or more downlink BWPs among the multiple downlink BWPs according to the configuration information of the downlink BWPs, monitoring a physical downlink control channel (PDCCH) indicating a preset message and/or receiving a physical downlink shared channel (PDSCH) carrying the preset message.

Similarly, the UE 2800 is also applicable to the carrier aggregation (CA) scenario. The uplink BWP(s) and/or downlink BWP(s) may be replaced with uplink carrier(s) and/or downlink carrier(s). With this, the load of the Pcell is reduced, and the number of users to access to the system (multiple cells) is increased.

Optionally, the configuration information of multiple uplink BWPs and/or the configuration information of multiple downlink BWPs are obtained through at least one of the following manners: system information; UE specific radio resource control (RRC) messages; obtaining through a manner of pre-specified configuration information of the uplink BWPs in a protocol; and obtaining through a manner of pre-specified configuration information of the downlink BWPs in a protocol.

Optionally, the preset message includes at least one of the following: a paging message, system information, and a message in random access.

Optionally, the message in random access includes at least one of the following: a random access response (RAR), a message MsgA, a message MsgB, a message Msg3, and a contention resolution message.

Optionally, the selecting one or more downlink BWPs among the multiple downlink BWPs according to the configuration information of the multiple downlink BWPs, monitoring the PDCCH for the preset message and/or receiving the PDSCH carrying the preset message includes at least one of the following: selecting one BWP according to the configuration information of the downlink BWPs and BWP indication in the PDCCH, and receiving the PDSCH carrying the preset message on the one BWP; and selecting one or more downlink BWPs among the multiple downlink BWPs according to the configuration information of the downlink BWPs to monitor the PDCCH for the preset message, selecting one BWP according to the BWP indication in the PDCCH to receive the PDSCH carrying the preset message on the one BWP, and continue to monitor the PDCCH for the preset message continues on the one or more multiple downlink BWPs after receiving the PDSCH carrying the preset message on the one BWP.

Optionally, the multiple uplink BWPs include one anchor uplink BWP and at least one non-anchor uplink BWP; and/or, the multiple downlink BWPs comprise one anchor downlink BWP and at least one non-anchor downlink BWP.

Optionally, the selecting one or more downlink BWPs among the multiple downlink BWPs according to the configuration information of the multiple downlink BWPs to monitor the PDCCH for the paging message and/or receive the PDSCH carrying the paging message includes at least one of the following: selecting one or more downlink BWPs among the multiple downlink BWPs according to the configuration information of the downlink BWPs and UE identification (ID) to monitor the PDCCH for the paging message and/or receive the PDSCH carrying the paging message; and selecting one or more downlink BWPs among multiple downlink BWPs according to the paging weight and UE ID corresponding to each downlink BWP contained in the configuration information of the downlink BWPs to monitor the PDCCH for the paging message and/or receive the PDSCH carrying the paging message.

Optionally, the selecting one or more uplink BWPs among the multiple uplink BWPs according to the configuration information of the uplink BWPs and transmitting the random access request includes at least one of the following: randomly selecting one or more uplink BWPs among multiple uplink BWPs according to the configuration information of the uplink BWPs and transmitting the random access request; selecting one or more uplink BWPs among the multiple uplink BWPs according to the configuration information of the uplink BWPs and random probability corresponding to each BWP and transmitting the random access request; and randomly selecting a resource for random access request from all resources for the random access requests in the multiple uplink BWPs and transmitting the random access request.

Optionally, the selecting one or more downlink BWPs among the multiple downlink BWPs according to the configuration information of the multiple downlink BWPs to monitor the PDCCH for the message in random access and/or receive the PDSCH carrying the message in random access includes at least one of the following: selecting the corresponding one or more downlink BWPs according to the configuration information of the downlink BWPs and one or more uplink BWPs transmitting the random access request to monitor the PDCCH for the message in random access and/or receive the PDSCH carrying the message in random access; and after transmitting a physical uplink shared channel (PUSCH) or receiving the PDSCH on the BWP indicated by the PDCCH, selecting the corresponding one or more downlink BWPs according to the configuration information of the downlink BWPs and one or more uplink BWPs transmitting the random access request to monitor the PDCCH for the message in random access and/or receive the PDSCH carrying the message in random access.

Optionally, the configuration information of an initial downlink BWP is obtained, wherein the configuration information of the initial downlink BWP includes one or more control channel resource sets (CORESET) and one or more search spaces for the PDCCH for the preset message, the one or more search spaces corresponds to at least one CORESET among the one or more CORESETs; and the PDCCH for the preset message on the one or more search spaces is monitored according to the configuration information of the initial downlink BWP; wherein the at least one CORESET among the one or more CORESETs is smaller than the bandwidth of the initial downlink BWP, and the bandwidth of the initial downlink BWP is greater than the maximum bandwidth supported by the UE.

Optionally, the monitoring the PDCCH for the preset message on the one or more search spaces includes: adjusting the center frequency position for the UE; receiving downlink data on different CORESETs; and decoding the PDCCH.

Optionally, the selecting one or more downlink BWPs among the multiple downlink BWPs according to the configuration information of the multiple downlink BWPs to monitor the PDCCH for the message in random access and/or receive the PDSCH carrying the message in random access includes at least one of the following: decoding and parsing the PDCCH for the message in random access, and obtaining a field in the PDCCH for the BWP on which the PDSCH carrying the message for random access transmission; determining at least one downlink BWP according to the configuration information of the downlink BWP(s) and BWP information indicated by the field in the PDCCH for the BWP on which the PDSCH carrying the message for random access transmission, receiving and decoding the PDSCH carrying the message in random access on the at least one downlink BWP.

Optionally, an uplink BWP indication for transmitting the PUSCH is obtained; and the PUSCH on the uplink BWP is transmitted according to the uplink BWP indication.

Optionally, the obtaining the uplink BWP indication for transmitting the PUSCH includes at least one of the following: obtaining the uplink BWP indication for transmitting the PUSCH from the random access response (RAR) or MsgB; inferring the uplink BWP indication for transmitting the PUSCH according to the BWP for the PDSCH; and determining the uplink BWP indication for transmitting the PUSCH according to the BWP on which transmitting the random access request.

The technical solutions provided in the embodiments of the present disclosure have at least the following beneficial effects.

In the embodiment of the present disclosure, through obtaining configuration information of multiple uplink bandwidth blocks (BWPs); selecting one or more uplink BWPs among the multiple uplink BWPs according to the configuration information of the uplink BWPs, and transmitting a random access request; and/or obtaining configuration information of multiple downlink BWPs; selecting one or more downlink BWPs among the multiple downlink BWPs according to the configuration information of the downlink BWPs, monitoring a physical downlink control channel (PDCCH) indicating a preset message and/or receiving a physical downlink shared channel (PDSCH) carrying the preset message; with this, it reduces loads of the initial BWP or Pcell and increases the number of accessed users of multiple cells.

For the content that is not described in detail in the UE provided in the embodiment of the present disclosure, reference may be made to the foregoing data transmission method. The beneficial effects achieved by the UE provided in the embodiment of the present disclosure are the same as the foregoing data transmission method, which are not repeated herein.

Based on the same inventive concept of the above embodiment 3, an embodiment of the present disclosure further provides a base station. A schematic structural diagram of the base station is shown in FIG. 29. The UE 2900 includes a third processing module 2901 and a fourth processing module 2902.

The third processing module 2901 is configured to transmit radio resource control (RRC) messages indicating configuration information of multiple uplink BWPs; the fourth processing module 2902 is configured to select one or more uplink BWPs among the multiple uplink BWPs according to the configuration information of the multiple uplink BWPs to receive a random access request, and transmit the PDCCH for RAR resource location on the downlink BWP corresponding to the received random access request. Alternatively/additionally, the third processing module 2901 is configured to transmit the RRC messages indicating configuration information of multiple downlink BWPs; the fourth processing module 2902 is configured to determine, according to the configuration information of the multiple downlink BWPs and UE ID corresponding to a paging message, one or more BWPs on which the PDCCH for the paging information and/or the PDSCH carrying the paging message are transmitted to the UE; transmitting the PDCCH for the paging message and/or the PDSCH carrying the paging message on the one or more BWPs.

The technical solutions provided in the embodiments of the present disclosure have at least the following beneficial effects: reducing loads of the initial BWP or Pcell and increases the number of accessed users of multiple cells.

For the content that is not described in detail in the base station provided in the embodiment of the present disclosure, reference may be made to the foregoing data transmission method. The beneficial effects achieved by the UE provided in the embodiment of the present disclosure are the same as the foregoing data transmission method, which are not repeated herein.

Those skilled in the art would understand that computer program instructions may be used to implement each block in these structural diagrams and/or block diagrams and/or flowchart diagrams and a combination thereof. Those skilled in the art would understand that these computer program instructions may be provided to a processor of a general-purpose computer, a special-purpose computer, or other programmable data processing methods, so that the solutions specified in the block or a plurality of blocks of the structural diagrams and/or block diagrams and/or flowchart diagrams disclosed in the disclosure are performed by the processor of the computer or other programmable data processing methods.

It should be appreciated by the person skilled in the art that each block as well as the combination of the blocks in the structural block graphs and/or block graphs and/or flowcharts may be implemented through computer program indications. It should be appreciated by the person skilled in the art that these computer program indications may be provided to general-purpose computer, dedicated computer or other processors capable of programming the data processing methods, to generate machines, so as to implement the methods specified in the block(s) of the structural block graphs and/or block graphs and/or flowcharts through the indications executed on the computer or other processors capable of programming the data processing methods.

It should be appreciated by the person skilled in the art that the various operations, methods, steps in the flow, measures and schemes discussed in the present application can be alternated, modified, combined or deleted. Furthermore, other operations, methods, steps in the flow, measures and schemes involving the various operations, methods, steps in the flow, measures and schemes discussed in the present application may also be alternated, modified, rearranged, dissolved, combined or deleted. Furthermore, other operations, methods, steps in the flow, measures and schemes having the same functions with the various operations, methods, steps in the flow, measures and schemes discussed in the present application may also be alternated, modified, rearranged, dissolved, combined or deleted.

The above description is only part of the embodiments of the present application. It should be noted that, for those of ordinary skill in the art, without departing from the principles of the present application, several improvements and retouches can be made. These improvements and retouches also should be regarded as the protection scope of the present application.

1. A method for reporting information, applied to a user equipment (UE), comprising:
receiving auxiliary scheduling information configuration and/or report indication carried in system information;
generating auxiliary scheduling information according to the auxiliary scheduling information configuration and/or the report indication; and
reporting the auxiliary scheduling information through at least one of Msg1, Msg3, and MsgA.

2. The method according to claim 1, further comprises at least one of the following:
the auxiliary scheduling information, comprising at least one of the following:
transmission Power Headroom Report (PHR); Data Volume (DV) information report in UE buffer; channel state information (CSI) report;
the auxiliary scheduling information configuration, comprising at least one of the following:
configuration information of Power Headroom, configuration information of DV in UE buffer, configuration information of a buffer status, and configuration information of CSI;
the report indication, comprising at least one of the following:
an indication of PHR, an indication of DV information report in UE buffer, an indication of Buffer Status Report (BSR), and an indication of CSI report.

3. The method according to claim 1, further comprising:
indicating at least one of a Medium Access Control (MAC) Control Element (CE), MAC header, MAC subheader and a Radio Resource Control (RRC) as a report format of the auxiliary scheduling information according to the system information and/or a Random Access Response (RAR).

4. The method according to claim 1, wherein the reporting the auxiliary scheduling information through at least one of Msg1, Msg3, and MsgA, comprising:
ordering the auxiliary scheduling information and logic channels according to priority rule, and generating Msg3 or MsgA for reporting; where the priority rule comprises: a priority of a cell radio network temporary identification (C-RNTI) MAC CE or data from an uplink common control channel (UL-CCCH) is higher, at least one of priorities of BSR MAC CE in Msg3, BSR MAC CE in MsgA, PHR MAC CE in Msg3 and PHR MAC CE in MsgA is lower.

5. The method according to claim 4, wherein the manner of determining a priority order of the logic channels comprises at least one of the following:
the priority order of the logic channels is specified in a protocol in advance;
the priority order of the logic channels is configured through the broadcasted system information; and
the priority order of the logic channels is configured through UE-specific RRC.

6. The method according to claim 1, wherein the auxiliary scheduling information comprises UE capability report, and the UE capability comprises at least one of the following:
maximum bandwidth supported by the UE, maximum number of receiving antennas of the UE, maximum number of transmitting antennas of the UE, maximum uplink multiple-input multiple-output (MIMO) layers supported by the UE, maximum downlink MIMO layers supported by the UE, UE storage space, UE's capability of early data transmission (EDT), UE's capability of reporting the CSI in Msg3, UE's capability of reporting the CSI in MsgA, UE's capability of reporting the PHR in Msg3, and UE's capability of reporting the PHR in MsgA.

7. The method according to claim 2, wherein after reporting that the DV information in the UE buffer is not zero, the method further comprises:
receiving an uplink grant for data transmission in the UE buffer, and transmitting uplink data according to the uplink grant;
a manner of indicating the uplink grant includes at least one of the following:
indicating the uplink grant according to new data indicator (NDI) in Downlink Control Information (DCI) scrambled by Temporary Cell Radio Network Temporary Identifier (TC-RNTI) or the Random Access Cell Radio Network Temporary Identifier (RA-RNTI); and
indicating the uplink grant in Msg4 or MsgB.

8. A method for receiving a message, applied to a UE, comprising:
detecting a first Primary Synchronization Signal (PSS) included in a first Synchronization Signal Physical Broadcast Channel Block (SSB) according to a predefined rule; and/or
detecting a second PSS included in a second SSB according to a second synchronization signal raster;
after detecting the first PSS, detecting a first Secondary Synchronization Signal (SSS) included in the first SSB, and receiving a first Physical Broadcast Channel (PBCH) included in the first SSB; and
after detecting the second PSS, detecting a second SSS included in the second SSB, and receiving a second PBCH included in the second SSB.

9. The method according to claim 8, wherein detecting the first PSS and/or the second PSS according to the predefined rule comprises:
detecting the first PSS according to a first synchronization signal raster; and/or
detecting the second PSS according to the second synchronization signal raster.

10. The method according to claim 8, further comprising:
detecting or decoding at least one of the first PSS, the first SSS, and the first PBCH according to at least one of a first preamble and a first scrambling code; and/or
detecting or decoding at least one of the second PSS, the second SSS, and the second PBCH according to at least one of a second preamble and a second scrambling code.

11. The method according to claim 8, wherein when the first PSS and the second PSS are the same, the first SSS and the second SSS are the same, and the first PBCH and the second PBCH are different, further comprising:
receiving the first PBCH on a first resource; and/or
receiving the second PBCH on a second resource;
wherein the frequency domain position of the second resource is adjacent to that of the first resource and/or the time domain position of the second resource is spaced from that of the first resource by a preset interval.

12. The method according to claim 8, wherein when the first SSB and the second SSB are the same, further comprises at least one of the following:
detecting a Physical Downlink Control Channel (PDCCH) indicating a first System Information Block (SIB) and/or a PDCCH indicating a second SIB according to a control resource set and/or a search space indicated in the PBCH, wherein the PDCCH indicating the first SIB is scrambled by a first System Information Radio Network Temporary Identifier (SI-RNTI), and the PDCCH indicating the second SIB is scrambled by a second SI-RNTI different from the first SI-RNTI;
detecting the PDCCH indicating the first SIB, according to the first control resource set and/or the first search space indicated in the PBCH; and
detecting the PDCCH indicating the second SIB, according to the second control resource set and/or the second search space indicated in the PBCH.

13. The method according to claim 12, further comprising:
determining whether a cell supports the second control resource set and/or the second search space according to an indication information in the PBCH.

14. A UE, comprising:
a first processing module, configured to receive auxiliary scheduling information configuration and/or report indication carried in system information;
a second processing module, configured to generate auxiliary scheduling information according to the auxiliary scheduling information configuration and/or the report indication; and
a third processing module, configured to report the auxiliary scheduling information through at least one of Msg1, Msg3, and MsgA.

15. A UE, comprising:
a fourth processing module, configured to detecting a first Primary Synchronization Signal (PSS) included in a first Synchronization Signal Physical Broadcast Channel Block (SSB) according to a predefined rule; and/or detecting a second PSS included in a second SSB according to a second synchronization signal raster; and
a fifth processing module, configured to after detecting the first PSS, detect a first Secondary Synchronization Signal (SSS) included in the first SSB, and receive a first Physical Broadcast Channel (PBCH) included in the first SSB; after detecting the second PSS, detect a second SSS included in the second SSB, and receive a second PBCH included in the second SSB.
